(19) United States
(12) Patent Application Publication
(10) Pub. No.: US 2026/0021542 A1
(43) Pub. Date: Jan. 22, 2026

(54) Tube Scarf Remover and Chopper Apparatus

(71) Applicant: ITSE Inc., Hawthorn Woods, IL (US)

(72) Inventor: Jaroslaw Szpakowski, Hawthorn Woods, IL (US)

(21) Appl. No.: 19/013,951

(22) Filed: Jan. 8, 2025

Related U.S. Application Data
(60) Provisional application No. 63/672,088, filed on Jul. 16, 2024.

(51) Int. Cl. B23K 37/08

(52) U.S. Cl. CPC B23K 37/08

(57) ABSTRACT

A tube scarf remover and chopper apparatus planes a weld bead from a tube and chops an advancing tube scarf from the scarfing point into scarf segments. The tube scarf remover and chopper apparatus includes a cutting deck and a rotary cutting apparatus. The deck has upper and lower deck sides, and front and rear sides. A scarf-letting aperture extends from the lower deck side to the upper deck side provides a cutting edge. The rotary cutting apparatus includes a rotatable cutting head and provides an axis of rotation. The upper deck side includes a recessed cavity. The rotatable cutting head is receivable and rotatable within the recessed cavity. The rotatable cutting head is directable into the advancing tube scarf. The cutting head and the cutting edge together cut the advancing tube scarf into scarf segments as the advancing tube scarf is advanced through the scarf-letting aperture.

### PRIOR HISTORY

This application claims the benefit of U.S. Provisional Patent Application No. 63/672,088 filed in the United States Patent and Trademark Office on 16 Jul. 2024, the specifications and drawings of which are hereby incorporated by reference thereto.

### TECHNOLOGICAL FIELD

The presently disclosed subject matter generally relates to an apparatus for removing and segmenting weld beads. More particularly, the presently disclosed subject matter relates to a tube scarf remover and chopper apparatus operable to both remove a weld bead from an external surface of a welded tube and cut the removed weld bead or tube scarf into smaller segments.

### BRIEF DESCRIPTION OF THE PRIOR ART

Metal tubes are often formed by connecting a first end of a metal sheet or stock material to a second end opposite the first end and welding the first and second ends together. To connect the first and second ends together, the metal sheet or stock material is formed longitudinally using a series of metal rolls, where at the end of the rolling stations, a longitudinal weld fastens the first and second ends to one another. The welding processes used vary depending on the material type, thickness, and tube manufacturer preference. Common processes include resistance welding, high frequency induction welding, and laser welding. After the material has been welded into the tube shape, excess weld bead material is preferably removed from the newly formed tube and the tube may be cut to specific lengths.

Tools to remove the excess weld bead material from a longitudinally welded metal tube are known in the art, and are typically employed directly following the welding process when the material remains in a heated, relatively more workable condition. When so removed, the excess weld bead material is removed from the metal tube in the form of a bead strip or tube scarf, which can be dangerously hot and can comprise sharp edges. Methods are known to direct or collect the removed bead strip or tube scarf so as to prevent the removed strip from coming into contact with workers or machinery in the vicinity of the removal process. A standard practice to direct and collect the removed bead strip is to wind the hot strip onto a spool on a winder, as disclosed for example in U.S. Pat. No. 5,368,218 ('218 patent), issued to Omura.

The '218 patent describes a weld bead cutter mechanism that continuously planes weld beads projecting from the seam weld zone of a seamed steel pipe. The weld bead cutter mechanism of the '281 patent fits into an assembly line for manufacturing seamed steel pipe after equipment which continuously molds sheet metal and welds the seam. The weld bead is planed off from the metal tube or steel pipe by a planing blade and is firstly bent or directed by a guide shoe fixed to the planing blade holder and directed through a groove in a bead guide or second guide element, which bead guide secondly directs the advancing tube scarf to a rotary bead chopper. The weld bead is then chopped into small pieces as the rotary bead chopper chops it against a stationary blade.

A gap or distance extends between the planing blade and the rotary bead chopper through which the advancing tube scarf must be firstly directed and re-directed by the guide shoe and bead guide. Although the author indicates this arrangement should help to ensures stable weld bead movement, this is not necessarily so. Tube scarves are subject to unpredictable curling once removed from the tube as they undergo rapid cooling. In this case, multiple guide elements help redirect the advancing tube scarf, but this can be problematic as discussed in more detail hereinafter in the detailed description section. Nevertheless, the weld bead cutter mechanism of the '218 patent is said to operate without necessarily requiring manual guidance of the weld bead, which greatly reduces the risk of a labor accident. The chopped pieces of weld bead fall into a disposal bucket or onto a waste discharge conveyor, so the weld bead cutter mechanism does not need to be stopped periodically to remove accumulated weld bead. As a result, the weld bead cutter mechanism and the seamed steel pipe assembly line can be run continuously for long periods of time.

Conventional weld bead winders similar to the one shown in the '218 patent have been used to plane weld beads from a weld zone of manufactured metal tube or pipe. A planing blade planes a weld bead from a pipe. A guide roller guides the planed weld bead upward and laterally away from pipe and planing blade towards a take up reel rotated by a motor. The motor is typically a pneumatic drive, which rotates the take up reel in weak torque. When the weld bead pipe is first fed onto the bead winder, an operator must manually guide the first portion of the weld bead as planed from the pipe above the guide roller and wind it onto the take up reel using a pincher tool. The weld bead thereafter planed is guided over the guide roller to the take up reel by means of the winding force applied by the motor. Because the take up reel has limited capacity, the metal tube manufacturing equipment must be stopped at periodic intervals to allow the operator to remove the wound up weld bead from the take up reel for disposal.

In other words, when the spool is full, the bead strip accumulation process must be stopped, and the bead strip must be cut so that the now-heavy full spool, or the wound strip, can be removed from the winder. To restart the strip accumulation process, a newly formed strip must be fed onto the winder. At start-up of the weld bead removal process, at spool changing time and at other times when there is a break in stripping process, an extremely hot and sharp end of the weld bead must be manually maneuvered towards the winder by an operator, e.g. with pincers. This process requires an elevated skill set on the part of the operator, in part, because the hot, sharp strip has a tendency to curl unpredictably. As a result, it is not unusual for accidents to occur and the operator to be lacerated and/or burned.

Other methods of handling the removed strip have been attempted. One method uses an angled bead removal tool and the removed bead strip or tube scarf is directed into a crusher beneath the tube, so that the bead strip or tube scarf is torn into pieces and dumped into a machine-moveable hopper. This overcomes the problem of moving a heavy, hot reel of wound strip. Another method uses an enclosed tube scarf chopper as exemplified by the tube scarf chopper sold under the brand SWEED® by Sweed Machinery, Inc. with current business address of 653 2nd Avenue, Gold Hill, Oregon, 97525. The SWEED® tube scarf chopper helps to enhance tube scarf operator safety and increase product uptime by eliminating operator exposure to tube scarf eliminating the need for a tube scarf winder.

The SWEED® tube scarf chopper is an enclosed unit having an input end into which the tube scarf is initially fed whereafter the chopper continually pulls the tube scarf into the unit for scarf chopping at line speed. The SWEED® tube scarf chopper creates a more efficient process and renders the process of tube or pipe manufacture simpler, quicker and safer for the line operator. However, both of these methods, and others like it, still require manual feeding of an end of the bead strip or tube scarf in order to start the chopping and disposal process. For safety reasons, an automatic strip feeding device is desirable and preferable.

To overcome the apparent shortcomings of prior art winding arrangements as introduced in the '218 patent, the author of the '218 patent presented a tube scarf chopper. To improve upon the teachings of the '218 patent, Calvo, Sr. et al. further authored U.S. patent application Ser. No. 09/209,691 now issued as U.S. Pat. No. 6,158,646 ('646 patent) on 12 Dec. 2000. The '646 patent describes a Weld Bead Chopper for use in combination with a scarfing tool which is intended to scarf a longitudinal weld bead from a tube. The chopper has a chopper blade which is rotatable about an axis which is substantially perpendicular to a longitudinal axis of the tube, and a stationary blade which is cooperable with the rotatable blade. The cooperating chopping surfaces of the rotatable and stationary blades are at a short distance from the weld bead, e.g. less than 100 mm, and preferably from 20 to 50 mm.

The scarfed weld bead enters an enclosed throat which has walls and internal guide features to guide a scarfed weld bead towards the cooperating chopping surfaces. The throat has a first guide adjacent to the scarfing tool which directs the scarfed weld bead towards a second guide element angled relative to a wall of the throat. The second guide faces the scarfing tool, and is adapted to guide the scarfed weld bead towards the cooperating chopping surfaces. The throat has a cross-sectional area substantially larger than the cross-sectional area of the scarfed weld bead. Additionally, the throat has a mouth which is sufficiently small to prevent the scarfed weld bead from exiting from the mouth.

It is noted that in all instances of tube scarf treatment, it is preferable to maintain continuous line movement of the tube for weld bead or tube scarf removal and a simultaneous tube scarf removal without consistent planning of the tube scarf from the tube or pipe. If there are periodic pauses or inconsistent movement of the tube scarf relative to the directed tube, imperfections can occur along the weld bead seam of the tube or pipe. These imperfections can have a deleterious effect on the tube or pipe made central to the manufacturing process. Defects in the tube or pipe, for example, are not only visually unappealing but also physically undesirable. The strength of the tube or pipe, may, for example, become compromised and may contribute to problems within the tube or pipe application.

While the SWEED® tube scarf chopper may be better suited to pull the tube scarf at a rate of speed that matches that of the directed tube against the planning tool thereby reducing the tendency for imperfections along the weld bead seam, its primary drawback is the manual feed of the tube scarf into the input end of the tube scarf chopper. Further, central to the Calvo, Sr. weld bead chopper is the throat through which the tube scarf is directed. Noting that the tube scarf is subject to unpredictable movements and curling following a substantially uniform rate of removal speed from the tube or pipe, the throat of the Calvo, Sr. weld bead chopper is ill-suited to properly direct a removed tube scarf from the weld bead seam so as to prevent imperfections along the weld bead seam.

Notably the scarfing or planing tool of the '646 patent is positioned adjacent the tube scarf-directing throat. The scarf-directing throat of the '646 patent comprises both a first guide adjacent to the scarfing tool which firstly directs the scarfed weld bead towards a second guide juxtaposed opposite the first guide. In other words, the second guide faces the scarfing tool, and is adapted to secondly guide the scarfed weld bead towards the cooperating chopping surfaces from the first guide. Both the first guide and the second guide are obliquely angled relative to the longitudinal axis of the tube scarf and the bidirectional guidance tends to bend the tube scarf as it is directed from the weld beam seam to the chopping site. This bending action exacerbates the tendency for the tube scarf to curl and move unpredictably, which can cause imperfections in the remaining weld portion and weld bead seam.

U.S. Pat. No. 9,713,831 ('831 patent), issued to Balta et al. discloses a Chopper and External Weld Bead Removal System Including Same. The '831 patent describes a system for removing and chopping an external weld bead from a tube including a weld bead cutting apparatus and a weld bead chopper apparatus for chopping the removed external weld bead. The weld bead cutting apparatus includes a cutting tool operative to cut and remove an external weld bead from a tube. The weld bead chopper apparatus, the weld bead chopper apparatus includes a first blade member, a second blade member mounted adjacent the first blade member, and a chopper actuator operable to forcibly rotate the first blade member about a rotation axis relative to the second blade member such that the first and second blade members cooperatively cut the removed external weld bead into smaller weld bead segments as the removed external weld bead is advanced through the chopper apparatus.

US Patent Application Publication No. 2013/0098220 ('220 Publication), authored by Seminew, discloses an External Bead Scarfer and Chopper for Pipes and Tubes. The '220 Publication describes a process and system for continuously removing an external weld bead from a moving pipe or tube that has been formed with a longitudinal weld seam extending along a longitudinal axis of the pipe or tube. A ribbon chamber, which is at least partially enclosed, receives scarfed ribbon on one end of the chamber. A chopping device located adjacent the other end of the chamber chops the ribbon into pieces, before the ribbon pieces can jam or disrupt the continuous system flow.

Both the '831 patent and the '220 Publication teach tube scarf choppers that chop or cut tube scarves using a reciprocating motion, which can create momentary reverse direction force vectors through the ever-advancing tube scarf resulting in imperfections in the finished tube or an increased tendency for the ever-advancing tube scarf to jam. It is further noted that both the '831 patent and the '220 Publication teach the use of a hydraulic cylinder to drive the chopping mechanisms. Hydraulically or linearly actuated drive mechanisms tend to pose speed limitations on worked products. In these cases, the driven choppers may be able to provide 60 cuts per minute and this maximum rate of chopping is ill-suited for high speed tube mills.

The prior art thus perceives a need for a weld bead cutter apparatus that operates to both remove the weld bead or tube scarf from a tube or pipe and immediately cut the tube scarf into scarf segments following its removal in a manner that prevents or minimizes bending action of the tube scarf between planing and segmenting events. This arrangement helps minimize imperfections that may otherwise form along the weld bead seam of the tube or pipe due to unpredictable directional movement of the tube scarf following planing action. The prior art, for example, is silent on a tube scarf removal apparatus having a cutting deck whereby a first surface of the cutting deck comprises a first cutting or planing tool, which planing tool directs the removed tube scarf toward a second cutting tool at a second surface of the cutting deck via a scarf-corralling aperture formed in the cutting deck.

A tube scarf-corralling aperture formed in a cutting deck so configured minimizes the distance between the initial planing site of the tube scarf and the subsequent segmentation of the tube scarf thereby minimizing any curling action of the tube scarf following the planing event and the subsequent segmentation. This minimized distance further enables continuous and constant movement of the tube scarf from the weld bead seam for preventing imperfections that may otherwise form along the weld bead seam. The prior art thus perceives a need for a weld bead removal apparatus so configured as summarized in more detail hereinafter.

### General Description

There is provided in accordance with an embodiment of the presently disclosed subject matter a tube scarf remover and chopper apparatus for planing a weld bead from a tube and chopping an advancing tube scarf into scarf segments. The tube scarf remover and chopper apparatus according to the presently disclosed subject matter comprises a cutting deck and a rotary cutting apparatus. In some embodiments, the cutting deck has an upper deck side, a lower deck side, a closed rear side, an open front side, and a scarf-letting aperture extending from the lower deck side to the upper deck side through the cutting deck. The scarf-letting aperture has a cutting edge.

The rotary cutting apparatus comprises a rotatable cutting head and defines an axis of rotation. The rotatable cutting head comprises at least one cutting tool. The lower deck side comprises a stationary planing tool configured to plane the weld bead from the tube when the tube is directed thereagainst in a first direction thereby forming an advancing tube scarf. The stationary planing tool continuously directs the advancing tube scarf toward the upper deck side in a second direction transverse to the first direction. The upper deck side comprises a recessed cavity and the rotatable cutting head is receivable in the recessed cavity such that the axis of rotation extends in parallel relation to the second direction.

The cutting tool is directable in a third direction transverse to the first and second directions toward the advancing tube scarf as continuously directed in the second direction through the scarf-letting aperture. The cutting tool and the cutting edge together cooperatively cut the advancing tube scarf into scarf segments as the advancing tube scarf bead is advanced through the scarf-letting aperture. In some embodiments, the recessed cavity has a cavity depth and is defined at the closed rear side by a radiused wall portion. In some embodiments, the radiused wall portion is semicircular. In some embodiments, the rotatable cutting head has a tool height no greater than the cavity depth.

In some embodiments, the rotatable cutting head comprises a plurality of cutting tool arms radially extending from the axis of rotation. In some embodiments, the cutting tool arms each have an arm length cooperable with the radiused wall portion to enable rotation thereof within the recessed cavity. In some embodiments, the cutting tool arms each comprise a hub portion and a sweeping portion such that the sweeping portion(s) are obliquely angled relative to the hub portion(s). In some embodiments, the sweeping portion is configured to direct the advancing tube scarf away from the hub portion as the cutting tool passes the scarf-letting aperture.

The scarf-letting aperture comprises a main aperture axis and, in some embodiments, the sweeping portion extends obliquely (i) rearwardly relative to the main aperture axis when approaching the scarf-letting aperture and (ii) forwardly when passing the scarf-letting aperture thereby directing the scarf segments in a forward and central direction toward the open front side of the cutting deck. In some embodiments, the cutting tools each comprise a sloped leading edge. The sloped leading edges are obliquely angled relative to an upper cavity surface of the recessed cavity at a first angle configured to direct the advancing tube scarf toward and against the cutting edge prior to cutting the advancing tube scarf into scarf segments.

In some embodiments, the cutting tools each comprise a sloped trailing edge. The trailing edges are obliquely angled relative to the upper cavity surface at a second angle, which second angle is lesser than the first angle and configured to direct the advancing tube scarf upwardly and rearwardly after the cutting tool passes the scarf-letting aperture. In some embodiments, the cutting tools each comprise a surface-opposing portion intermediate the sloped leading edge and the sloped trailing edge. The surface-opposing portion extends in parallel relation to the upper cavity surface. In some embodiments, the surface-opposing portion comprises a portion thickness, which portion thickness is less than a scarf thickness of the advancing tube scarf. The portion thickness enables the advancing tube scarf to advance at the sloped trailing edge upwardly and rearwardly unimpeded.

In some embodiments, the tube scarf remover and chopper apparatus according to the presently disclosed subject matter comprises a cavity-enclosing lid positioned adjacent the rotatable cutting head such that the rotary cutting head is capped within the recessed cavity when in a closed configuration. In some embodiments, the cavity-enclosing lid comprises a segment-directing cavity configured to direct the scarf segments away from the recessed cavity. In some embodiments, the segment-directing cavity comprises a cavity mouth coextensive with the open front side thereby forming an L-shaped segment outlet. In some embodiments, the segment-directing cavity comprises sloped surfacing from a cavity terminus portion thereof to the cavity mouth. The sloped surfacing of the segment-directing cavity directs the scarf segments toward the cavity mouth.

In some embodiments, the tube scarf remover and chopper apparatus may further comprise a chute in communication with front sides of the cutting deck and the cavity-enclosing lid at the L-shaped segment outlet. The chute is configured to direct the scarf segments from the L-shaped segment outlet. In some embodiments, the cutting deck comprises a plate-receiving cavity formed in the upper cavity surface. A replaceable scarf-letting plate having a plate aperture is receivable in the plate-receiving cavity and the plate aperture provides the cutting edge, In some embodiments, the cutting elements of the tube scarf remover and chopper apparatus are replaceable or interchangeable when cutting edges become dull or worn through use.

There is provided in accordance with another embodiment of the presently disclosed subject matter a tube scarf chopper apparatus for chopping an advancing tube scarf The tube scarf chopper apparatus according to the presently disclosed subject matter comprises a cutting deck and a rotary cutting apparatus. The cutting deck has a first deck side, a second deck side, a rear side, a front side, and a scarf-letting aperture extending from the first deck side to the second deck side through the cutting deck. The scarf-letting aperture has a cutting edge at least along a portion thereof.

The rotary cutting apparatus comprises a rotatable cutting head and an axis of rotation. The rotatable cutting head comprises at least one cutting tool. The second deck side comprises a recessed cavity. The rotatable cutting head is receivable in the recessed cavity such that the axis of rotation extends in parallel relation to a tube scarf as it advances through the scarf-letting aperture from the first deck side to the second deck side. The cutting tool is directable transversely relative to the tube scarf so advancing. The cutting tool and the cutting edge together cooperatively cut the tube scarf into scarf segments as the tube scarf advances through the scarf-letting aperture.

### BRIEF DESCRIPTION OF THE DRAWINGS

Other features and objectives of the presently disclosed subject matter will become more evident from a consideration of the following brief descriptions of patent drawings.

FIG. 1 is a first top perspective view of the tube scarf remover and chopper apparatus according to the presently disclosed subject matter positioned adjacent a directed welded length of tube having a weld bead at a beaded end and a remaining weld portion at a bead free end.

FIG. 2 is a perspective view of a welded length of tube having a weld bead at a beaded end and a remaining weld portion at a bead free end and depicting a tube scarf being removed from the welded length of tube.

FIG. 3A is an end view of a welded length of tube showing a weld bead at the beaded end of the welded length of tube.

FIG. 3B is an end view of a welded length of tube showing a remaining weld portion at the bead free end of the welded length of tube.

FIG. 3C is a fragmentary enlarged sectional view as enlarged and sectioned from FIG. 3A to show in greater clarity a radial dimension of the weld bead otherwise shown in FIG. 3A.

FIG. 3D is a fragmentary enlarged sectional view as enlarged and sectioned from FIG. 3B to show in greater clarity a smoother outer diameter surface of the remaining weld portion otherwise shown in FIG. 3B.

FIG. 4A is a front view of a prior art conventional tube scarf winder arrangement demonstrating a relatively long length of tube scarf extending from a scarfing point to a take up reel of the tube scarf winder arrangement.

FIG. 4B is a side view of the prior art conventional tube scarf winder arrangement otherwise shown in FIG. 4A.

FIG. 5A is a cross-sectional view of a prior art chopping apparatus made the subject of U.S. Pat. No. 6,158,646 demonstrating opposed guide elements within a tube scarf receiving and directing throat, which guide elements deflect the advancing tube scarf through the throat.

FIG. 5B is a cross-sectional view of a prior art chopping apparatus made the subject of U.S. Pat. No. 5,368,218 demonstrating first and second guide elements opposite a space or gap, which first and second guide elements firstly and secondly deflect the advancing tube scarf toward a chopping site.

FIG. 6A is a diagrammatic top view of a short length of welded tube showing an imperfection within a remaining weld portion intermediate the length thereof.

FIG. 6B is a diagrammatic cross-sectional side view of an upper tube portion of the length of welded tube otherwise shown in FIG. 6A depicting a pit imperfection within the remaining weld portion intermediate the length thereof.

FIG. 7 is a front elevational view of the tube scarf remover and chopper apparatus and directed length of tube otherwise shown in FIG. 1.

FIG. 8 is a top plan view of the tube scarf remover and chopper apparatus and directed length of tube otherwise shown in FIG. 1.

FIG. 9 is a first lateral side view of the tube scarf remover and chopper apparatus and a first end view of the directed length of tube otherwise shown in FIG. 1 showing the beaded end of the tube.

FIG. 10 is a second lateral side view of the tube scarf remover and chopper apparatus and a second end view of the directed length of tube otherwise shown in FIG. 1 showing the bead free end of the tube.

FIG. 11 is a front elevational view of the tube scarf remover and chopper apparatus and directed length of tube otherwise shown in FIG. 1 with a chute feature removed to reveal an L-shaped scarf segment outlet provided by the tube scarf remover and chopper apparatus.

FIG. 12 is a top perspective view of a cutting deck of the tube scarf remover and chopper apparatus according to the presently disclosed subject matter showing a recessed cavity and a scarf-letting plate positioned at an upper cavity surface of the recessed cavity.

FIG. 13 is a front view of the cutting deck otherwise shown in FIG. 12 showing a cavity depth of the cutting deck.

FIG. 14 is a top plan view of the cutting deck otherwise shown in FIG. 12 showing a radiused wall portion of the recessed cavity at a closed rear side of the cutting deck.

FIG. 15 is a bottom plan view of the cutting deck according to the presently disclosed subject matter showing a scarf-letting aperture positioned at a stationary scarf-planing tool mounted to the bottom side of the cutting deck and a portion of a rotating cutting tool viewable through the scarf-letting aperture.

FIG. 16 is a perspective view of a rotary cutting apparatus according to the presently disclosed subject matter showing a motor housing at an upper end thereof and a rotatable cutting head comprising a plurality of cutting tools at a lower end thereof.

FIG. 17 is a top end perspective view of the rotary cutting apparatus otherwise shown in FIG. 16.

FIG. 18 is a bottom end perspective view of the rotary cutting apparatus otherwise shown in FIG. 16.

FIG. 19 is a top plan view of the rotatable cutting head of the rotary cutting apparatus according to the presently disclosed subject matter showing a circular path or space swept by the cutting tools mounted to the rotatable cutting head.

FIG. 20 is a side elevational view of a main cutting head body of the rotatable cutting head according to the presently disclosed subject matter showing a tool height of the rotatable cutting head.

FIG. 21 is a top perspective view of the cutting deck and rotatable cutting head of the tube scarf remover and chopper apparatus according to the presently disclosed subject matter showing the rotatable cutting head received within the recessed cavity with a cutting tool positioned over the scarf-letting plate.

FIG. 22 is a top plan view of the cutting deck and rotatable cutting head of the tube scarf remover and chopper apparatus otherwise shown in FIG. 21.

FIG. 23A is a first sequential view of a cutting tool arm being directed over the scarf-letting plate showing a first angle of inclination of the cutting tool arm rearwardly angled relative to a main aperture axis of a plate aperture formed in the scarf-letting plate.

FIG. 23B is a second sequential view of the cutting tool arm otherwise shown in FIG. 23A being directed over the scarf-letting plate showing a second angle of inclination of the cutting tool arm rearwardly angled relative to the main aperture axis of the plate aperture.

FIG. 23C is a third sequential view of the cutting tool arm otherwise shown in FIG. 23A being directed over the scarf-letting plate showing a third angle of inclination of the cutting tool arm rearwardly angled relative to the main aperture axis of the plate aperture.

FIG. 23D is a fourth sequential view of the cutting tool arm otherwise shown in FIG. 23A being directed over the scarf-letting plate showing a fourth angle of inclination of the cutting tool arm rearwardly angled relative to the main aperture axis of the plate aperture.

FIG. 23E is a fifth sequential view of the cutting tool arm otherwise shown in FIG. 23A being directed over the scarf-letting plate showing a first angle of inclination of the cutting tool arm forwardly angled relative to the main aperture axis of the plate aperture.

FIG. 23F is a sixth sequential view of the cutting tool arm otherwise shown in FIG. 23A being directed over the scarf-letting plate showing a second angle of inclination of the cutting tool arm forwardly angled relative to the main aperture axis of the plate aperture and a vector showing a forward and to the right direction of a scarf segment as cut by a cutting tool mounted to the cutting tool arm and a cutting edge of the plate aperture.

FIG. 23G is a seventh sequential view of the cutting tool arm otherwise shown in FIG. 23A being directed over the scarf-letting plate showing a third angle of inclination of the cutting tool arm forwardly angled relative to the main aperture axis of the plate aperture.

FIG. 23H is an eighth sequential view of the cutting tool arm otherwise shown in FIG. 23A being directed over the scarf-letting plate showing a fourth angle of inclination of the cutting tool arm forwardly angled relative to the main aperture axis of the plate aperture.

FIG. 24 is a top perspective view of the cutting deck of the tube scarf remover and chopper apparatus according to the presently disclosed subject matter showing a plate-receiving cavity formed in the upper cavity surface of the recessed cavity.

FIG. 25 is an enlarged top plan view of the scarf-letting plate received within the plate-receiving cavity and depicting the main aperture axis of the plate aperture formed in the scarf-letting plate.

FIG. 26 is an enlarged bottom plan view of the scarf-letting aperture and stationary scarf-planing tool mounted to the bottom side of the cutting deck and a portion of a rotating cutting tool viewable through the scarf-letting aperture.

FIG. 27 is an exploded perspective view of the scarf-letting plate and stationary scarf-planing tool exploded from the cutting deck to show relative positions of the scarf-letting plate and scarf-planing tool.

FIG. 28 is a cross-sectional perspective view of the cutting deck and scarf-letting plate through the scarf-letting aperture formed in the cutting deck and the plate aperture formed in the scarf-letting plate.

FIG. 29 is a top perspective view of the cutting deck and rotatable cutting head of the tube scarf remover and chopper apparatus according to the presently disclosed subject matter showing a tube scarf advancing upwardly through the cutting deck as a welded tube with weld bead is directed from right to left.

FIG. 30 is a cross-sectional perspective view of the cutting deck and scarf-letting plate through the scarf-letting aperture formed in the cutting deck and the plate aperture formed in the scarf-letting plate showing a tube scarf advancing upwardly through the cutting deck as a welded tube with weld bead is directed against the scarf-planing tool.

FIG. 31 is a fragmentary enlarged cross-sectional perspective view of the cutting deck and scarf-letting plate through the scarf-letting aperture formed in the cutting deck and the plate aperture formed in the scarf-letting plate otherwise shown in FIG. 31, enlarged to show in greater detail the tube scarf advancing upwardly through the cutting deck as the welded tube with weld bead is directed against the scarf-planing tool.

FIG. 32 is an enlarged end view of a cutting tool according to the presently disclosed subject matter positioned above a fragmentary upper cavity surface of the recessed cavity, enlarged to show relative dimensional characteristics of the cutting tool relative to the upper cavity surface.

FIG. 33A is a first sequential diagrammatic depiction of a cutting tool being directed to the left toward an advancing tube scarf being directed upwardly through the scarf-letting apertures formed in the cutting deck and scarf-letting plate.

FIG. 33B is a second sequential diagrammatic depiction of the cutting tool and advancing tube scarf otherwise depicted in FIG. 33A, the cutting tool being directed to the left toward the advancing tube scarf being further directed upwardly through the scarf-letting apertures formed in the cutting deck and scarf-letting plate.

FIG. 33C is a third sequential diagrammatic depiction of the cutting tool and advancing tube scarf otherwise depicted in FIG. 33A, the cutting tool being directed to the left and directing the advancing tube scarf into engagement with a cutting edge positioned to the left of the scarf-letting apertures formed in the cutting deck and scarf-letting plate.

FIG. 33D is an enlarged fourth sequential diagrammatic depiction of the cutting tool and advancing tube scarf otherwise depicted in FIG. 33A, the cutting tool being directed to the left after having cut the advancing tube scarf to form a scarf segment and passing over the scarf-letting apertures formed in the cutting deck and scarf-letting plate such that the advancing tube scarf follows a sloped trailing edge of the cutting tool.

FIG. 34 is a bottom plan view of the cavity-enclosing lid according to the presently disclosed subject matter showing a scarf-deflecting cavity formed in a portion of the cavity-enclosing lid.

FIG. 35 is a front elevational view of the tube scarf remover and chopper apparatus according to the presently disclosed subject matter with a scarf-directing chute removed to show an L-shaped scarf outlet formed by the scarf-letting cavity and the recessed cavity at the front side of the cutting deck and the cavity-enclosing lid.

FIG. 36 is a perspective view of tube scarf remover and chopper apparatus according to the presently disclosed subject matter shown positioned adjacent a length of tube with the scarf-directing chute removed and the rotary cutting apparatus and cavity-enclosed lid pivoted about a pivot axis to allow access to the recessed cavity and rotatable cutting head.

FIG. 37 is a front elevational view of tube scarf remover and chopper apparatus and length of tube otherwise shown in FIG. 36.

FIG. 38 is a lateral side view of tube scarf remover and chopper apparatus and length of tube otherwise shown in FIG. 36.

FIG. 39 is a lateral side view of tube scarf remover and chopper apparatus and length of tube otherwise shown in FIG. 38 with scarf-directing chute attached to the open front side of the cutting deck.

FIG. 40 is a second top perspective view of the tube scarf remover and chopper apparatus according to the presently disclosed subject matter positioned adjacent a directed welded length of tube having a weld bead at a beaded end and a remaining weld portion at a bead free end and showing the rotary cutting apparatus and cavity-enclosing lid pivoted to a closed configuration thereby enabling removal and segmentation of the tube scarf from the directed welded length of tube.

### DETAILED DESCRIPTION OF THE EMBODIMENTS

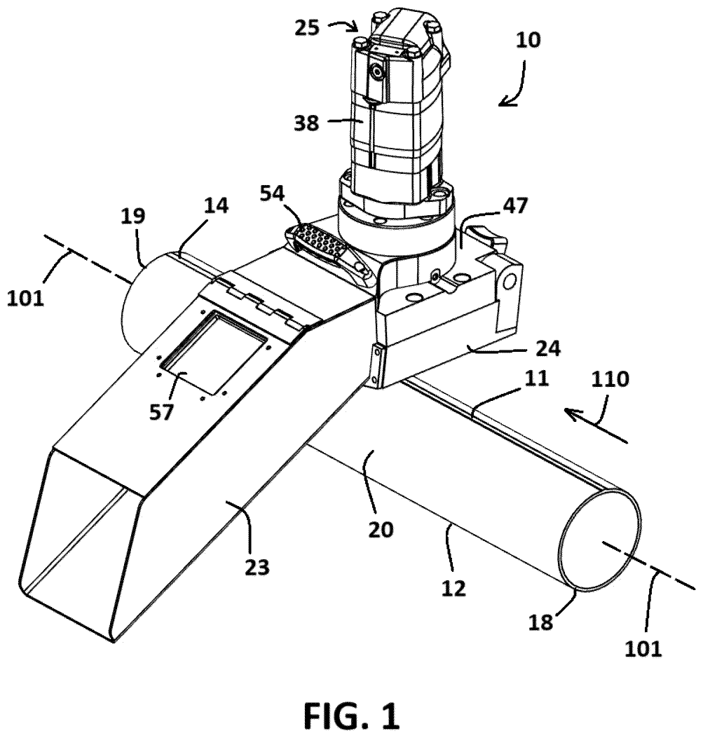

Referring now the drawings with more specificity, the presently disclosed subject matter concerns a tube scarf remover and chopper apparatus 10 as generally depicted and introduced in FIG. 1. The tube scarf remover and chopper apparatus 10 is operable to both plane a weld bead 11 from a tube or pipe 12 and chop or cut the weld bead 11 as it is removed from the tube or pipe 12. The planed weld bead 11 is hereinafter referred to as a tube scarf 13. In other words, the tube scarf 13 is continually advanced from the tube or pipe 12 as the weld bead 11 is planed from the tube or pipe 12. Referencing FIG. 1, the reader will consider a short length of longitudinally welded tube 12 positioned adjacent the tube scarf remover and chopper apparatus 10 and directed as at 110 from right to left. A beaded end of the tube is referenced at 18 and a bead-free end of the tube 12 is referenced at 19. The beaded end 18 includes a weld bead 11. As the tube 12 is processed by the tube scarf remover and chopper apparatus 10, the tube 12 comprises a remaining weld portion 14 along a weld seam 15 at the bead-free end 19.

In manufacturing, a tube scarf 13 is a byproduct of the process of removing excess welding material (i.e., a weld bead 11) from a tube or pipe 12, and can refer to weld bead material that is removed from both an inner diameter and an outer diameter of the tube or pipe 12. In these specifications, the presently disclosed tube scarf remover and chopper apparatus 10 and its associated methods focus upon tube scarfing an outer diameter 103 of longitudinally welded tubes or pipes 12 (hereinafter more simply referred to as tubes 12). Referencing FIGS. 3A to 3D, the reader there consider an outer diameter 103 of the tube 12. The process of removing the excess material or weld bead 11 from a tube 12 may be referred to as tube scarfing, and is often performed to prepare the tube 12 for precision applications. The tube scarf remover and chopper apparatus 10 according to the presently disclosed subject matter is intended for tubes or pipes having an outer diameter of up to 6 inches and a wall thickness up to 0.25 inches.

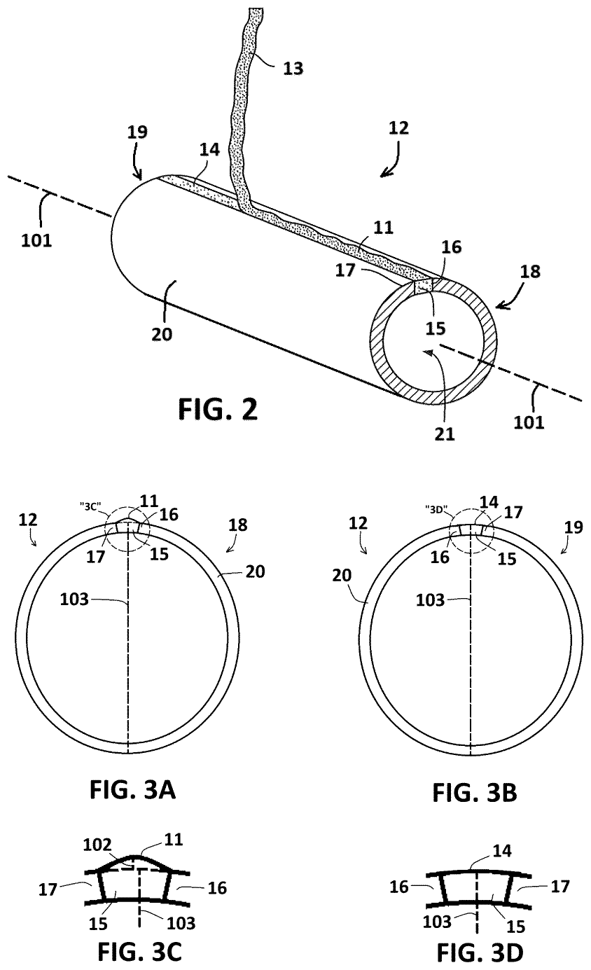

Within these specifications, the expression, “weld bead” as at 11, generally refers to that portion of a weld along a longitudinal tube or pipe seam that extends radially outward from a circular outer diameter 103 of a tube 12. Referencing FIGS. 3A and 3C, for example, the reader will there consider weld bead 11. Referencing FIG. 3C in particular, the reader will see the weld bead 11 comprises a radial dimension 102 that effectively increases the outer diameter 103 of the tube 12. The expression, “tube scarf” as at 13, generally refers to the bead strip or bead ribbon that is removed or planed from the tube 12 to render the outer circumference 103 of the tube 12 more circular or substantially more planar at the weld seam 15 and remaining weld portion 14 as comparatively depicted and referenced in FIGS. 2 to 3D and particularly depicted in FIGS. 3B and 3D.

The tube scarf remover and chopper apparatus 10 can be used to remove or plane a longitudinally extending, external excess weld bead 11 from a welded tube 12. More particularly and with reference to FIG. 2, the tube 12 has a cylindrical side wall 20 that has been formed or rolled (e.g., from metal sheet stock) and welded so that opposed longitudinal edges 16 and 17 of the side wall 20 are joined by a weld along a lengthwise weld seam as at 15. The tube 12 may form a longitudinally extending inner passage 21 and has a longitudinal tube axis 101 extending generally parallel to the weld seam 15 and weld bead 11. The reader will further consider the beaded end as at 18 in FIGS. 2, 3A and 3C, and the bead-free end as at 19 in FIGS. 2, 3B and 3D. The tube scarf remover and chopper apparatus 10 provides a bead-free tube 12 exemplified by the bead-free end 19 as variously depicted and referenced.

In some applications, the tube side wall 20 is formed (e.g., rolled) and fed downstream to a welding station where the edges 16 and 17 are welded to one another thereby forming the weld seam 15 and weld bead 11. The welded tube 12 is further and continuously directed downstream to a bead removal station where the weld bead 11 is planed from the tube 12. The tube mill line speed is determined by the tube manufacturer, and depends on a number of factors. The chopping speed of the tube scarf remover and chopper apparatus 10 must be adjusted to the tube line speed. The tube mill can run from 50 ft/min for large heavy-duty mills up to 700 ft/min for small-diameter mills. If the mill speed is higher, the chopper rotation speed needs to be higher. For example, a mill being run at 400 ft/min will require a chopper rotation speed on the order of 120 RPM to achieve the desirable scarf segment length. A mill at 100 ft/min will require a chopper rotation speed of about 40 RPM.

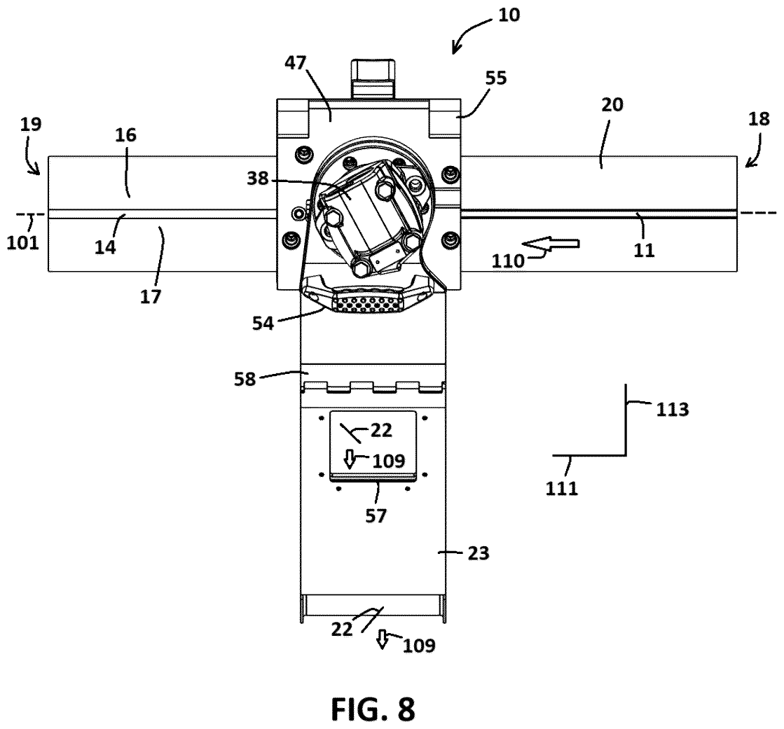

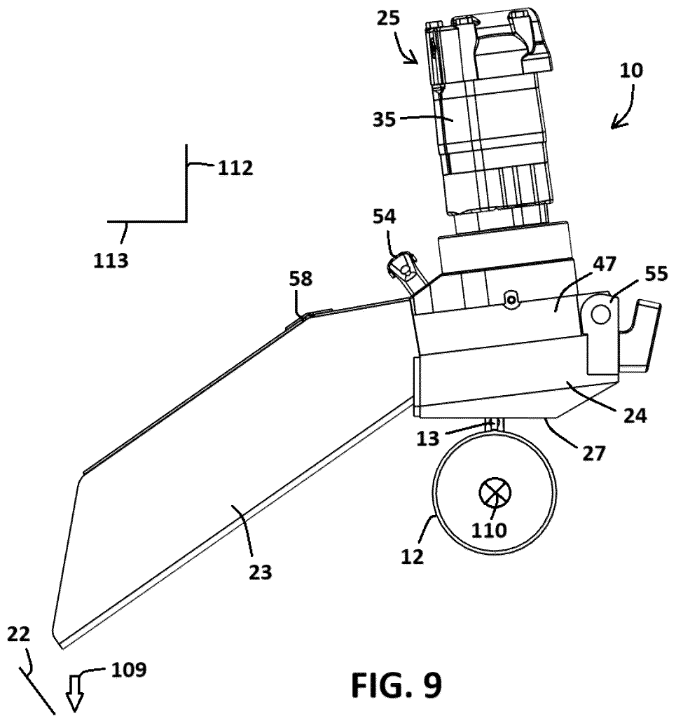

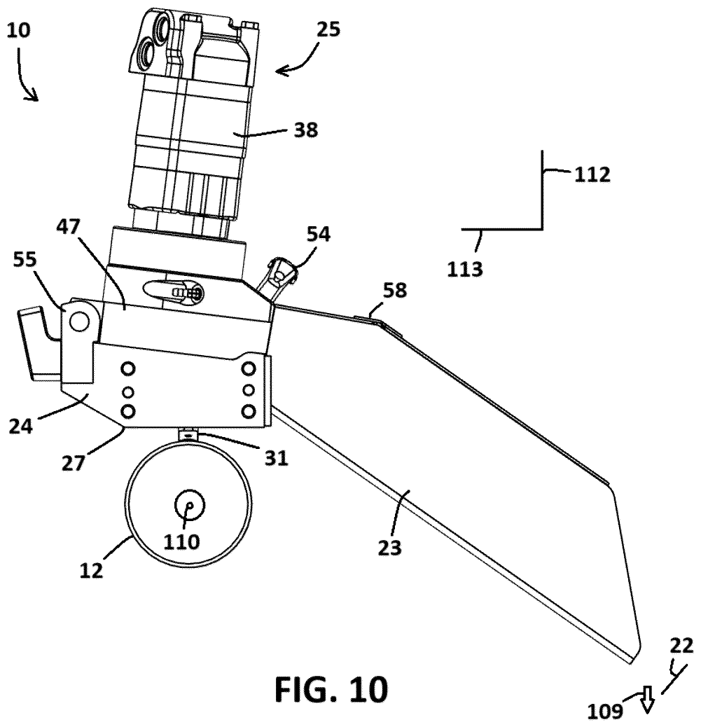

The weld bead 11 is firstly planed or scarfed from the tube 12 by the tube scarf remover and chopper apparatus 10 as the tube is directed along the mill line and the continuously re-directed tube scarf 13 is secondly chopped, cut or segmented into scarf segments 22 by the tube scarf remover and chopper apparatus 10. A remaining weld portion 14 remains on the tube 12 to bond the edges 16 and 17 and complete the transverse circumference of the tube 12. In some embodiments, the scarf segments 22 may be directed as at arrows 109 away from the tube scarf remover and chopper apparatus 10 by way of a chute 23 as generally depicted in FIGS. 1, 7 to 10, 39 and 40.

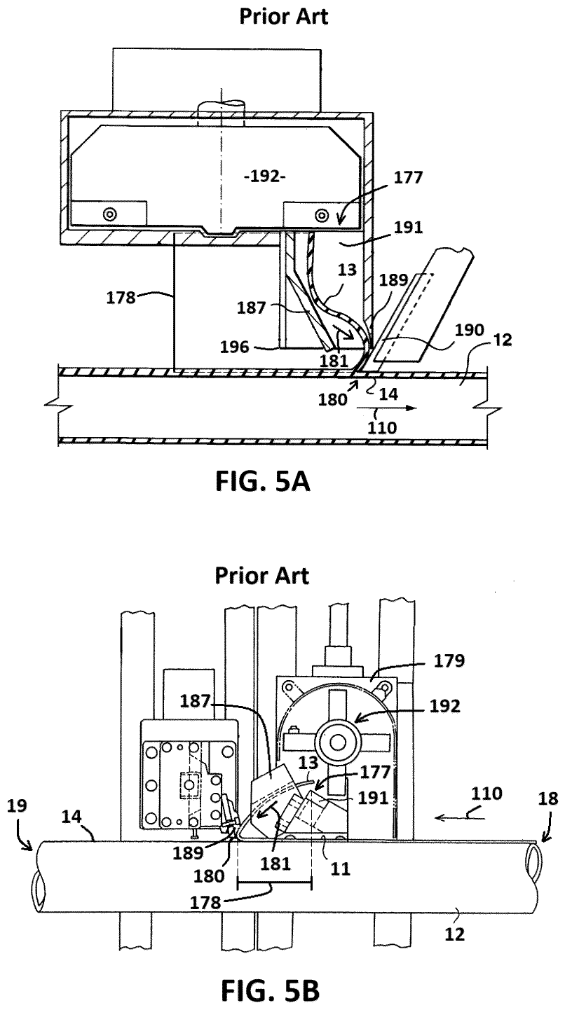

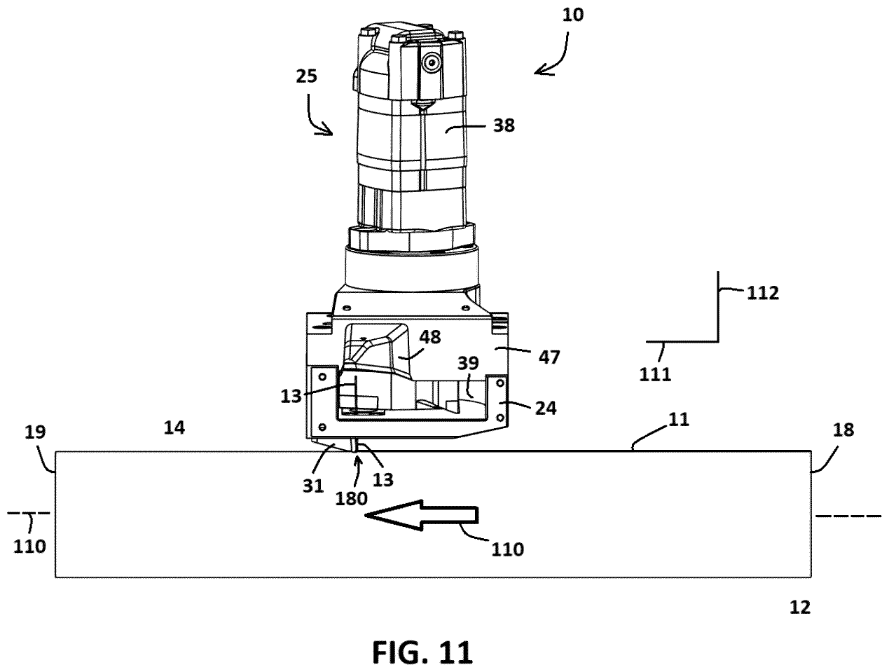

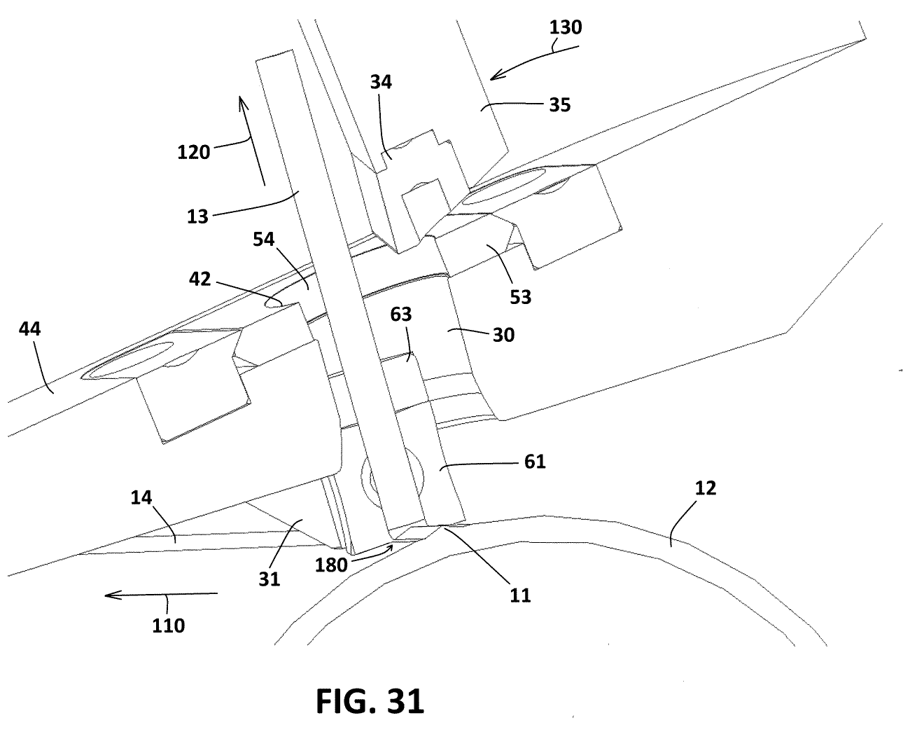

As introduced hereinabove, tube scarves 13 are often dangerously hot and sharp, and particularly so for line operators. The temperature at the scarfing point 180 is typically on the order of 1500 degrees Fahrenheit. If the mill is set to run at a relatively slower rate, the temperature at the scarfing point 180 may be lower, and conversely, if the mill is set to run at a relatively faster rate, the temperature may be higher. The distance between the welding point and the scarfing point 180 (as comparatively referenced in FIGS. 5A and 5B versus FIGS. 11 and 31) is typically 2 to 5 feet, but dependent upon the mill layout. The distance between the welding point and the scarfing point 180 can have an effect on the temperature at the scarfing point 180. Traditional processing methods involving operator interactions with the tube scarves 13 at these temperatures can often lead to injuries and downtime.

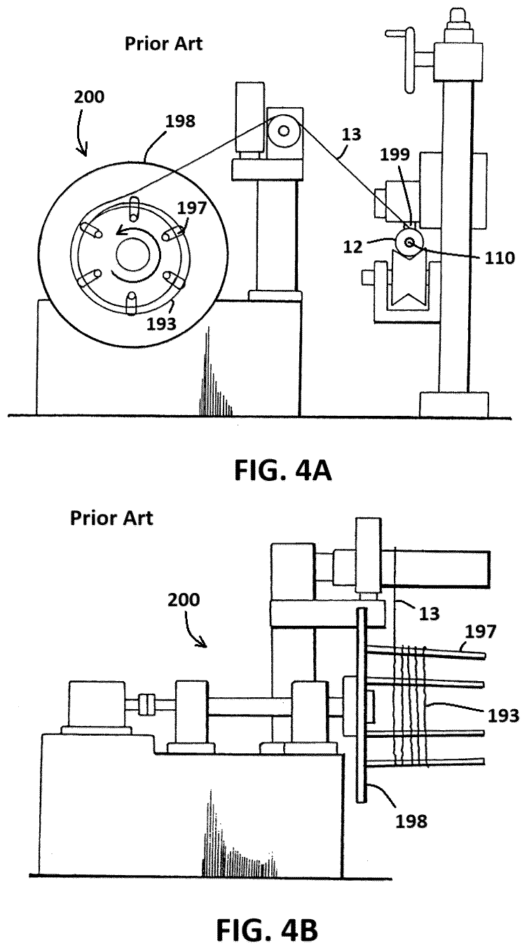

In this regard, the reader is directed to FIGS. 4A and 4B. Referencing FIGS. 4A and 4B, the reader will there consider a conventional and exemplary tube scarf winder arrangement 200 as otherwise presented for consideration in the '218 patent. The welded tube 12 is driven against a planing tool 199 thereby removing the weld bead in the form of a tube scarf 13. The tube scarf 13 referenced in FIGS. 4A and 4B is manually fed by a line operator to a scarf winder 198, typically with the use of a pincher mechanism. Because the take up reel 197 of the scarf winder 198 has limited capacity, metal tube manufacturing equipment with arrangements of this type must be stopped at periodic intervals to allow the line operator to remove the wound up tube scarf 193 from the take up reel 197 for disposal.

In other words, when the take up reel or spool 197 is full, the tube scarf accumulation process must be stopped, and the tube scarf 13 must be cut so that the take up reel 197, or the wound tube scarf 193, can be removed from the winder arrangement 200. To restart the scarf accumulation process, a newly formed tube scarf 13 must be fed onto the winder arrangement 200. At start-up of the weld bead removal process, at reel changing time and at other times when there is a break in stripping process, an extremely hot and sharp end of the tube scarf 13 must be manually maneuvered towards the winder arrangement 200. This process requires an elevated skill set on the part of the line operator, in part, because the hot, sharp tube scarf 13 has a tendency to curl unpredictably. As a result, it is not unusual for accidents to occur and the operator to be lacerated and/or burned.

While highly dangerous, the revolutionary speed 194 of the scarf winder 198 can be adjusted and synchronized with the speed of the directed tube 12 as at arrow 110. In this sense, a tube scarf winder arrangement 200 of the general type shown in FIGS. 4A and 4B tends to reduce imperfections in the finished tube 12 after scarfing given the ability to synchronize tube scarf take-up at the winder arrangement with tube scarf removal at the scarfing point 180. It will thus be understood that a tube scarf winder arrangement 200 of the general type depicted in FIGS. 4A and 4B has a relatively high potential for injury to line operators given the need to manually feed the take up reel 197 with the tube scarf 13, but a relatively low potential for imperfections in the finished tube 12 given synchronized movement of the take up reel 197 and the tube 12 as directed at 110.

Tube scarf choppers have been developed to help to lower the potential for injury to line operators by eliminating the need to manually feed a tube scarf winder arrangement and can increase productivity by making the process safer and more efficient. Tube scarf choppers, however, have shown a marked increase in imperfections in the finished tube 12. Imperfections typically result when movement of the tube scarf 13 from the scarfing point 180 is discontinuous. This interrupted movement tends to occur when the tube scarf 13, subject to unpredictable curling, is directed out of synchronized movement with the tube 12 as continuously directed at arrow 110 or cut in a manner that is not swift and clean.

In this regard, the reader is firstly directed to FIG. 5A. Referencing FIG. 5A, for example, the reader will there consider a prior art image from the '646 patent describing an improved prior tube scarf chopper. In particular, the reader is directed to the throat 196 of the arrangement there depicted. The arrangement shown in FIG. 5A comprises a rotatable cutter 192 and a stationary blade 191. The throat 196 is located adjacent to and upstream from the scarfing tool 190. The throat 196 includes a first guide element 189 which is adjacent to the scarfing tool 190 and comprises a first oblique face within the throat 196, which first oblique face is obliquely angled relative to the scarfing tool 190. The throat 196 further includes a scarf bead deflector or second guide element 187 which faces the scarfing tool 190. The tube scarf 13 is firstly directed by the first guide element 189 toward the scarf bead deflector 187, which scarf bead deflector 187 comprises a second oblique face substantially parallel to the first oblique face. The scarf bead deflector 187 then secondly directs the tube scarf 13 toward the rotatable cutter 192.

The reader is secondly directed to FIG. 5B. Referencing FIG. 5B, the reader will there consider a prior art image from the '218 patent upon which the '646 patent attempted to build. The prior tube scarf chopper shown in the '218 patent includes a planing blade at the scarfing point 180; a guide shoe or first guide element 189 and a bead guide or second guide element 187. A stationary blade 191 and a rotary bead chopper 192 are supported by a block 179. A pipe or tube 12 is forced from right to left as at arrow 110 and the planing blade at the scarfing point 180 planes a weld bead or tube scarf 13 from the tube 12. The guide shoe or first guide element 189 firstly bends the tube scarf 13 up and toward the bead guide or second guide element 187, which second guide element 187 redirects the tube scarf 13 toward the chopping site 177, where the tube scarf 13 is chopped into scarf segments 22 by rotary bead chopper 192 and the stationary blade 191.

Noting that the tube scarf 13 is subject to unpredictable curling once removed from the tube 12, the non-linear directed movement of the tube scarf 13 from the first guide element(s) 189 to the second guide elements 187 either through the throat 196 of the '646 patent or through the bead guide of the '218 patent tends to create discontinuous tube scarf movement, having momentary force vectors 181 directed toward the scarfing point 180 resulting in imperfections 186 in the remaining weld portion 14 of the finished tubes 12. While it is noted that in theory there is no operator intervention needed to direct tube scarf movement in either the '646 patent or the '218 patent, it is further noted that tube scarf movement is unpredictable once the weld bead 11 is removed from the tube or pipe 12 at the scarfing point 180.

In both cases, the second guide element(s) 187 must be used to guide the tube scarf 13 to the chopping site 177. The redirection provided by the first and second guide elements 189/187 tend to create momentary force vectors 181 which not only may result in imperfections 186 in the finished tube 12, but may also contribute to jams. In both cases there is a significant gap 178 between the scarfing point 180 and the chopping site 177. Tube scarves 13 undergo significant and rapid cooling once the weld bead 11 is formed. When chopping actions at the chopping site(s) 177 are distanced from the scarfing point(s) 180, the tube scarf 13 may curl unpredictably while undergoing rapid cooling and redirection. These processes may not only create the momentary force vectors 181 that result in imperfections 186, but can also contribute to a reduced life of the chopper blades at the chopping site 177 due to hardening of the tube scarf 13 while cooling.

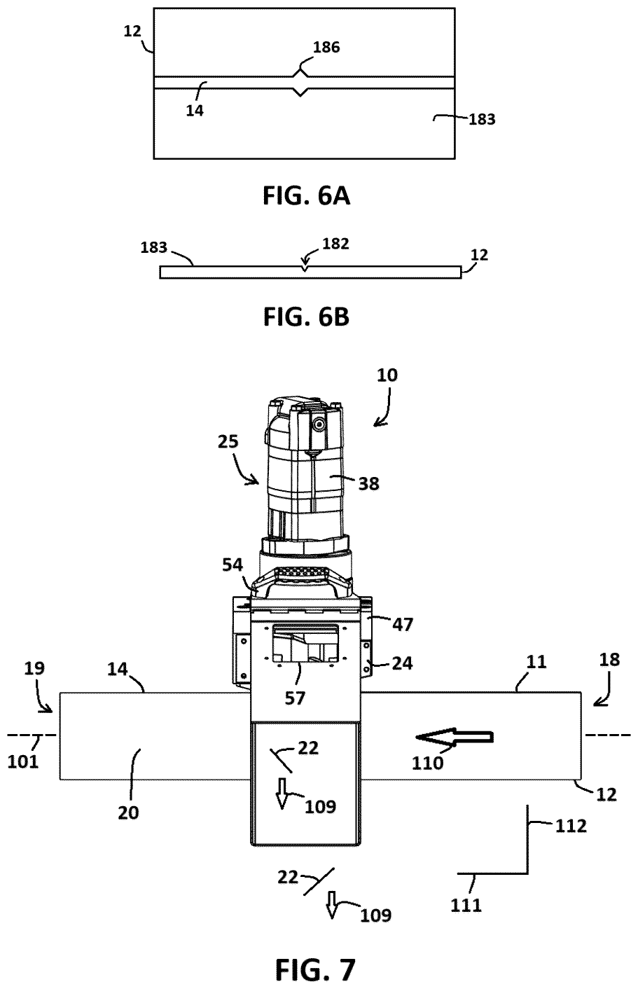

Comparatively referencing FIGS. 6A and 6B, the reader will there consider imperfections 186 formed in the remaining weld portion 14 of the finished tube 12. Discontinuous movement of the tube scarf 13 away from the scarfing point 180, however brief, may, in some cases, force the scarfing tool 190 into the outer surface 183 of the tube 12 as it is otherwise continuously directed as at arrow 110. This directed movement of the scarfing tool 190 or planing tool into the outer surface 183 can create pit imperfections 182 in the outer surface 183 as generally depicted and referenced in FIG. 6B. These pit imperfections 182 or more generalized imperfections 186 are problematic as they compromise the integrity of the tube or pipe 12 being welded and smoothed.

In this regard, the reader is invited to consider Oil Country Tubular Goods or OCTG standards. So-called OCTG tubular products are a group of steel pipes used in the oil and gas industry, as well as for hydrogen generation, transportation, and storage. OCTG pipes are designed to withstand extreme temperatures, high pressure, and corrosive environments. OCTG pipes are made from seamless or welded steel and are usually very hard, with a martensitic structure. Chromium and manganese are the primary alloys used to make OCTG pipes, which helps to ensure durability and high cohesion. OCTG pipes are subject to a quality inspection process and must meet American Petroleum Institute specifications to ensure they meet the required safety and quality standards.

To meet these standards, tube or pipe manufacturers may implement Ultrasonic Testing equipment to inspect such tubes during production. Ultrasonic Testing measurement or UT measurement refers to a non-destructive testing method that uses high-frequency sound waves to measure the thickness of a material by sending a pulse of sound through it and calculating the time it takes for the echo to return, essentially allowing for accurate thickness gauging from one side of the material only. Such testing is commonly used in industrial inspections to detect flaws or assess the integrity of components like pipes and welds. If UT measurement detects an imperfection as at imperfection 186, the producer must either scrap the finished tube or downgrade it. Other industries, such as the automotive industry, can reject imperfect tubes based more simply on aesthetic flaws in the outer surface 183.

The presently disclosed subject matter attempts to build upon and improve the state of the art related to tube scarf choppers with a view toward minimizing the distance between the bead-planing or scarfing point 180 and the chopping site to enhance the overall safety of the process while simultaneously enabling the tube scarf 13 to advance unimpeded through this minimized distance so that imperfections 186 along the remaining weld portion 14 and the weld seam 15 are reduced or eliminated. To address these primary objectives, the tube scarf remover and chopper apparatus 10 according to the presently disclosed subject matter is further presented in FIGS. 7 to 11. The tube is directed in a first direction 110 along the X axis 111. The tube scarf 13 is advanced in a second direction 120 transverse to the first direction 110 along the Y axis 112. The cutting action is directed in a third direction 130 generally transverse to both the first and second directions 110 and 120 along the Z axis 113.

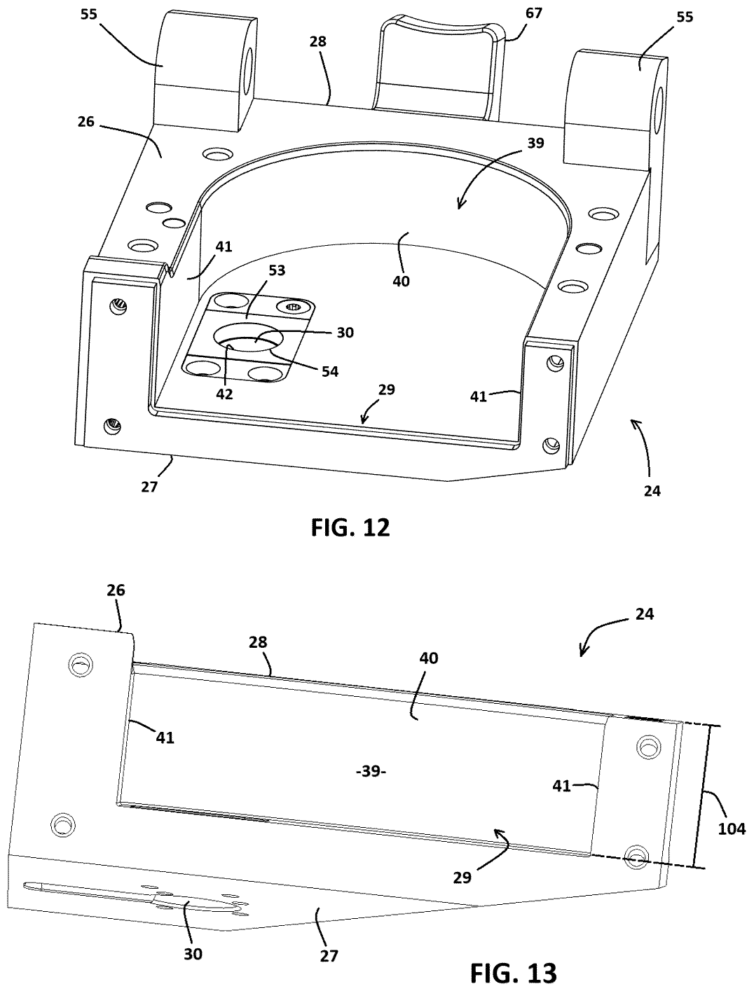

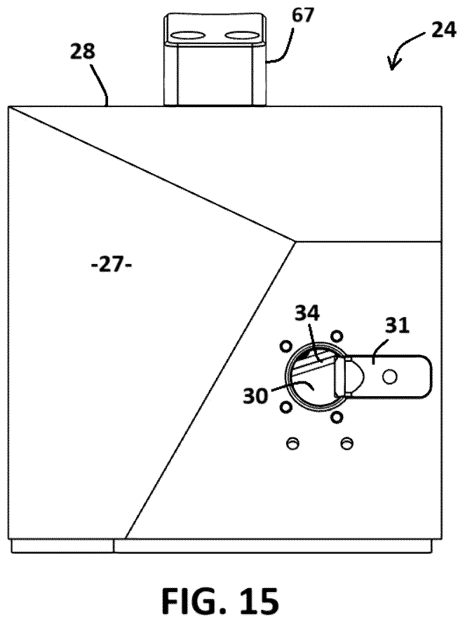

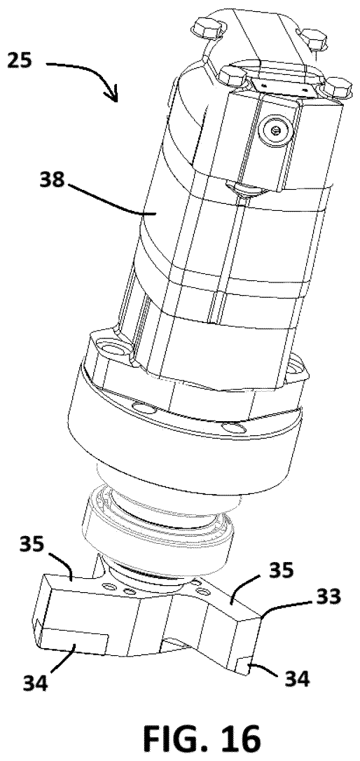

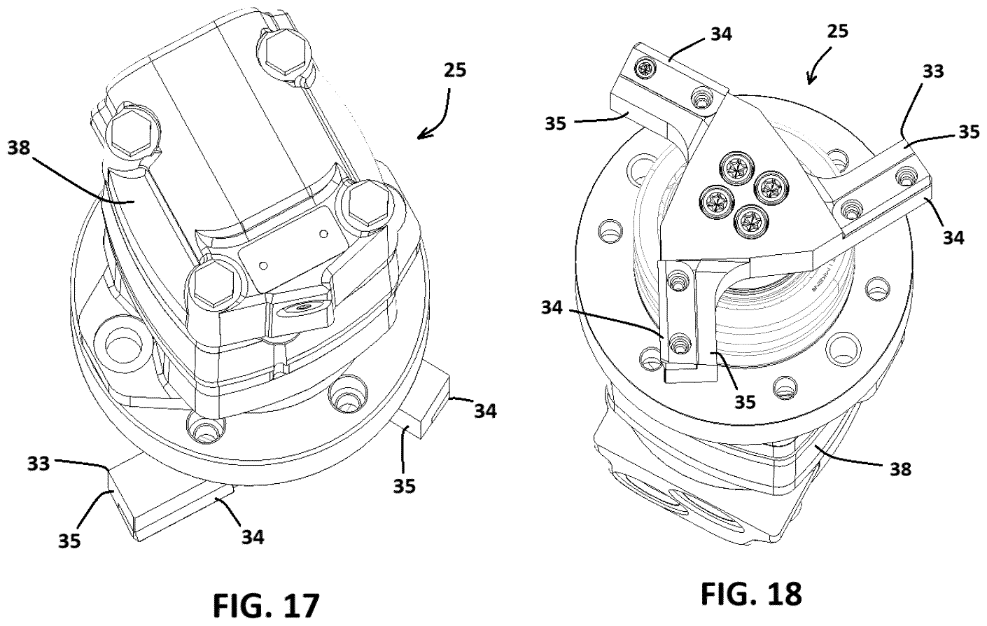

The tube scarf remover and chopper apparatus 10 comprises a uniquely configured cutting deck 24 as depicted and referenced in FIGS. 12 to 15 and a rotary cutting apparatus 25 as depicted and referenced in FIGS. 16 to 18. The cutting deck 24 of the tube scarf remover and chopper apparatus 10 comprises an upper or first deck side 26; a lower or second deck side 27; a closed rear side 28; and an open front side 29. A scarf-letting aperture 30 extends from the lower deck side 27 to the upper deck side 26 through the cutting deck 24. The diameter of the circular scarf-letting aperture 30 is sized according to the general thickness of the tube scarf 13 and the outer diameter 103 of the tube 12 being produced. The diameter of the scarf-letting aperture 30 as illustrated is on the order of 1.1 inches. For tubes 12 with larger outer diameters 103, the inner diameter of the scarf-letting aperture 30 should correspondingly increase. The inner diameter of the scarf-letting aperture 30 should never exceed 1.625 inches.

In some embodiments, the lower deck side 26 comprises a stationary cutting or planing tool 31 mounted thereto and configured to plane or cut and remove the weld bead 11 from the tube 12 when the tube 12 is directed thereagainst in the first direction as at 110. The stationary cutting tool 31 continuously directs the tube scarf 13 as it is removed from the tube 12 toward the upper deck side 26 in the second direction 120 generally transverse to the first direction 110. In some embodiments, at least a portion 63 of the cutting tool 31 may partially extend into the scarf-letting aperture 30 to ensure the tube scarf 13 is properly directed to and through the scarf-letting aperture 30 as generally depicted in FIG. 31.

The rotary cutting apparatus 25 comprises an upper motor housing 38 and a lower rotatable cutting head 33 rotatable about an axis of rotation 102 and driven by a motor housed within the motor housing 38. In some embodiments, the rotatable cutting head 33 comprises at least one cutting tool 34. In some embodiments, the rotatable cutting head 33 comprises a plurality of cutting tools 34. In the embodiment shown in FIGS. 16 to 19, the rotatable cutting head 33 comprises an array of three cutting tools 34. In some embodiments, the rotatable cutting head 33 comprises a plurality of cutting tool arms 35 that radiate or radially extend from the axis of rotation 102.

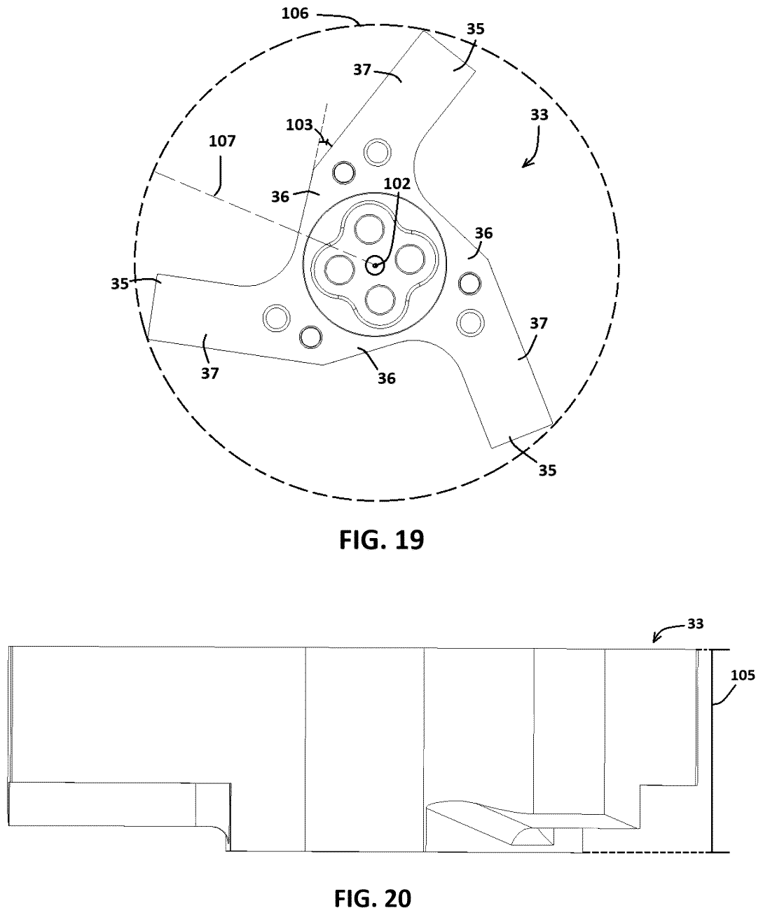

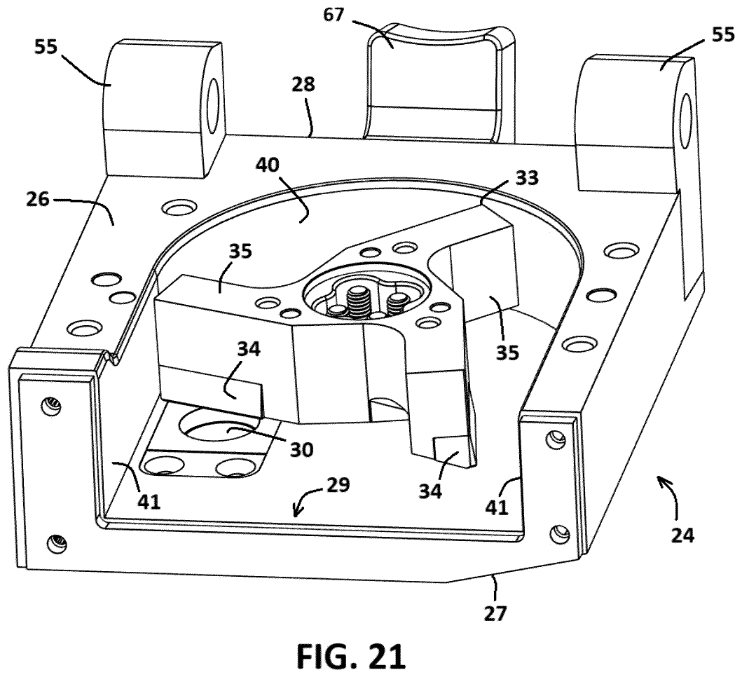

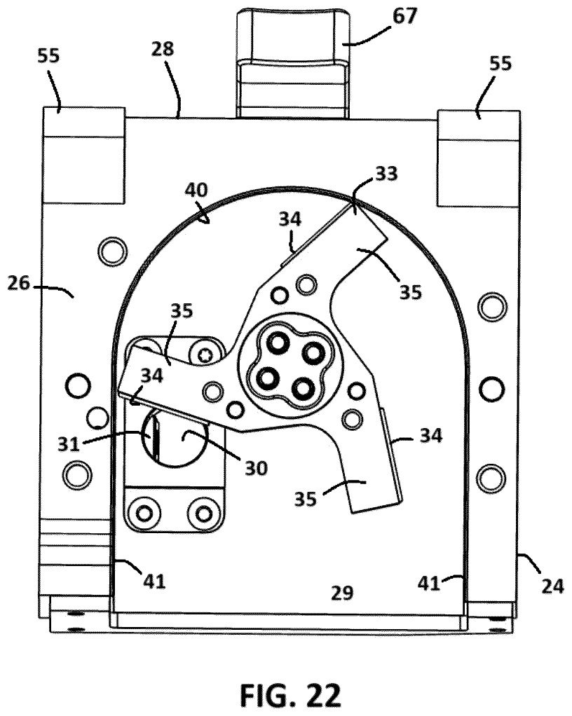

In some embodiments, the cutting tool arms 35 each comprise a hub portion 36 and a sweeping portion 37. In some embodiments, the sweeping portion 37 is obliquely angled relative to the hub portion 36 as generally depicted and referenced in FIG. 19. Referencing FIG. 19, the reader will note the sweeping portion 37 is obliquely angled relative to the hub portion 36 as at angle 103. This configuration helps to continually sweep the tube scarf 13 toward a stationary cutting edge 42 at or along an upper portion of the scarf-letting aperture 30 and helps eliminate momentary force vectors 181 that would otherwise be directed toward the scarfing point 180 thereby reducing the potential for the formation of imperfections 186.

The upper deck side 26 comprises a recessed cavity 39 configured to receive both the tube scarf 13 via the scarf-letting aperture 30 and the rotatable cutting head 33. The rotatable cutting head 33 is receivable and rotatable within the recessed cavity 39 such that the axis of rotation 102 generally extends in parallel relation to the second direction 120 of the advancing tube scarf 13. The recessed cavity 39 has a cavity depth as at 104 and is defined at the closed rear side 27 by a radiused wall portion 40 and as comparatively depicted and referenced in FIGS. 12 to 14.

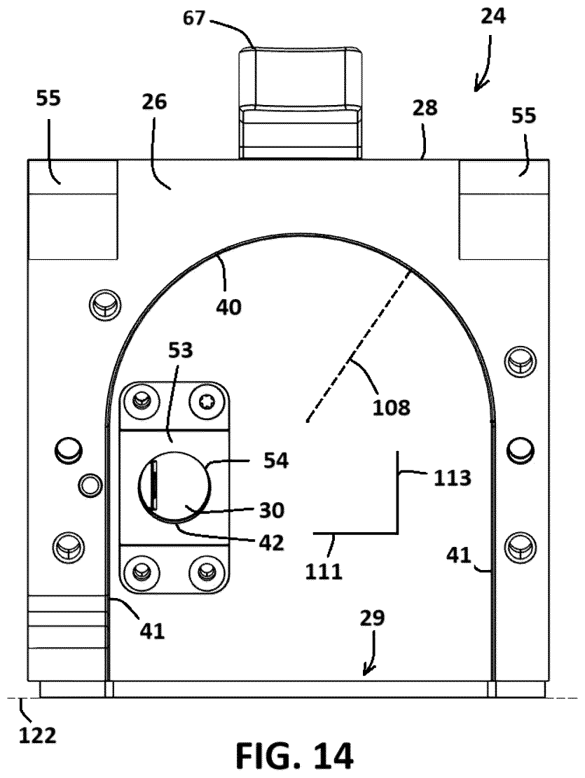

In some embodiments, the radiused wall portion 40 of the recessed cavity 39 is semicircular and extends coextensively with planar side walls 41 that extend toward the open front side 29 from the radiused wall portion 40. The planar side walls 41 and radiused wall portion 40 thereby form a generally U-shaped recessed cavity 39 for enclosing the rotatable cutting head 33. In some embodiments, the rotatable cutting head 33 has a tool height 105 no greater than the cavity depth 104. In some embodiments, the rotatable cutting head 33 sweeps through a circular path 106 having a radius 107 no greater than the radius 108 of the semicircular radiused wall portion 40 as comparatively depicted in FIGS. 14 and 19. In some embodiments, the cutting tool arms 35 each have an arm length cooperable with the radiused wall portion 40 to enable rotation of the rotatable cutting head 33 within the recessed cavity 39.

In other words, the recessed cavity 39 of the cutting deck 24 is configured to receive the rotatable cutting head 33 such that the rotatable cutting head 33 and cutting tools 34 may sweep through the circular path 106 defined within the arcuate portion of the U-shaped recessed cavity 39 along radiused wall portion 40. Notably, the scarf-letting aperture 30 is positioned radially within the circular path 106 such that the cutting tools 34 sweep thereover. The cutting tools 34 are directable through the circular path 106 in the third direction 130 generally transverse to the first direction 110 and the second direction 120 toward the tube scarf 13 as continuously directed in the second direction 120 through the scarf-letting aperture 30. The scarf-letting aperture 30 has a cutting edge 42 at least along an upper portion thereof. In some embodiments, the cutting edge 42 is formed at an aperture side closest to the open front side 29. Together the cutting tool 34 and the cutting edge 42 cooperate to cut or chop the tube scarf 13 into scarf segments 22 as the tube scarf 13 is advanced through the scarf-letting aperture 30.

It is noted that cutting edges of cutting implements are subject to wear and tear. In this regard, it is preferable to replace cutting edges from time to time. The cutting tools 34 are removably attachable to the cutting arms 35 and can be swapped out for replacement cutting tools 34 as may be required. Further, the stationary cutting tool 31 comprises a replaceable planing blade 61, the lower edge of which is radiused as at 62 corresponding to the outer diameter 103 of the tube 12. The planing blade 61 can also be swapped and replaced with replacement planing blades as may be required. To address periodic replacement of the cutting edge 42, the tube scarf and chopper apparatus 10 may further comprise a scarf-letting plate 53 in some embodiments.

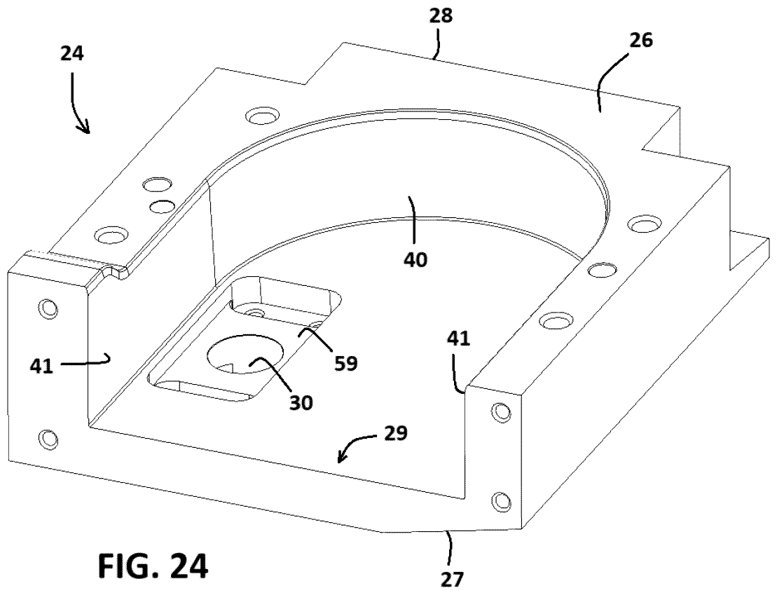

The scarf-letting plate 53 is removably attachable to the cutting deck 24 and comprises a plate aperture 54 coextensive with the scarf-letting aperture 30 when mounted to the cutting deck 24. In this regard, at least a portion of the plate aperture 53 provides the cutting edge 42 in some embodiments. In some embodiments, the scarf-letting plate 53 is received in a plate-receiving cavity 59 formed in the cutting deck 24 as generally depicted and referenced in FIG. 24. The scarf-letting plate 53 may be anchored within the plate-receiving cavity 59 by flanking anchor elements 60 which can be secured to the cutting deck 24 via threaded apertures and fasteners. These flanking anchor elements 60 can be removed as may be required when replacing a worn or damaged scarf-letting plate 53.

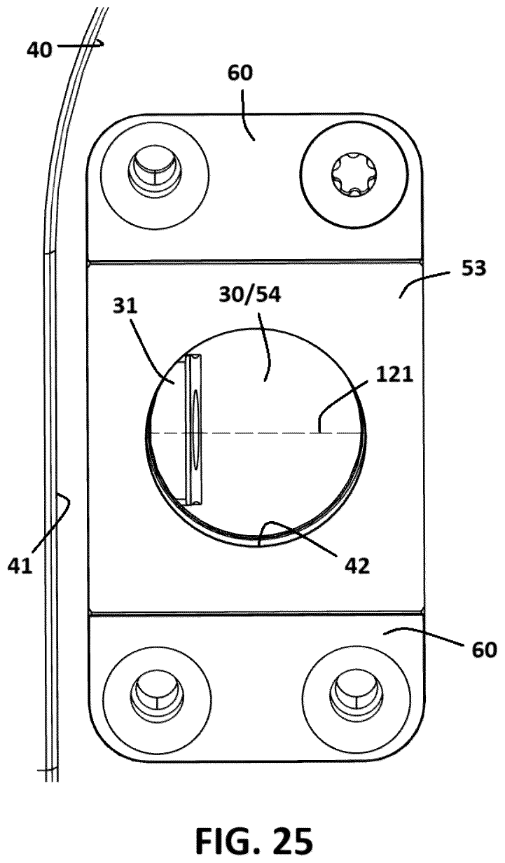

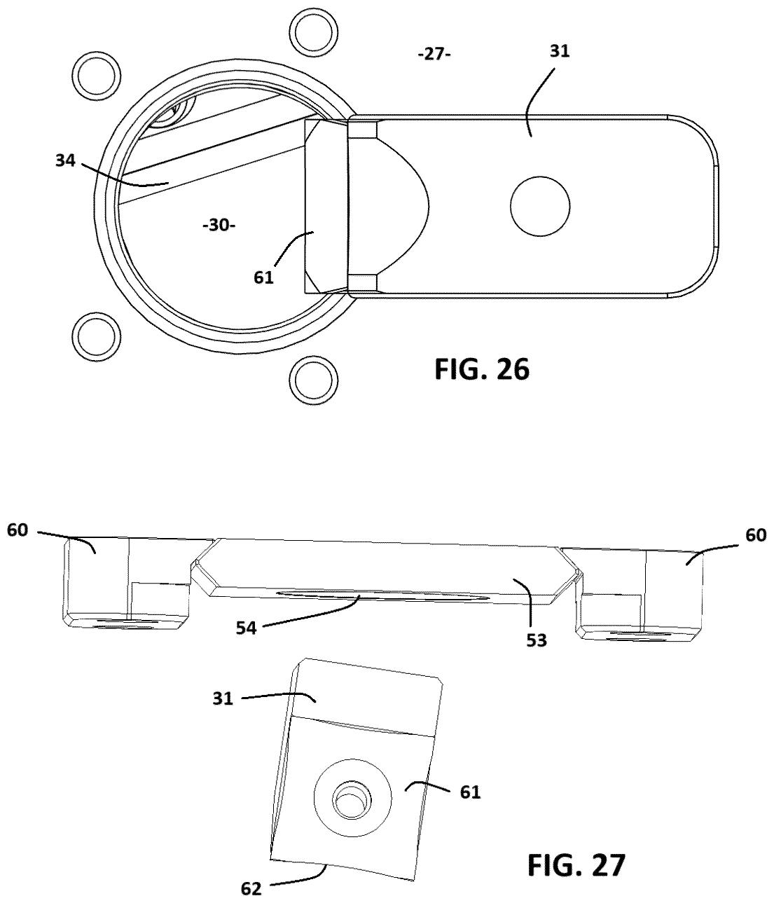

In some embodiments, the scarf-letting aperture 30 may be formed within the cutting deck 24 at a position conducive to prevent momentary force vectors 181 directed toward the scarfing point 180. The placement of the scarf-letting aperture 30 and the configuration of the cutting tool arms 35 cooperate to more effectively direct the advancing tube scarf 13 toward the cutting edge 42. In this regard, the scarf-letting aperture 30 and the plate aperture 54 may comprise a main aperture axis 121 that extends parallel to a deck outlet plane 122 at the open front side 29. In this regard, the reader is firstly directed to FIGS. 14 and 25. Comparatively referencing FIG. 14 versus FIG. 25, the reader will there consider the main aperture axis 121 extends along the X axis 111 and the deck outlet plane 122 extends along the X axis and out of the page along the Y axis 112.

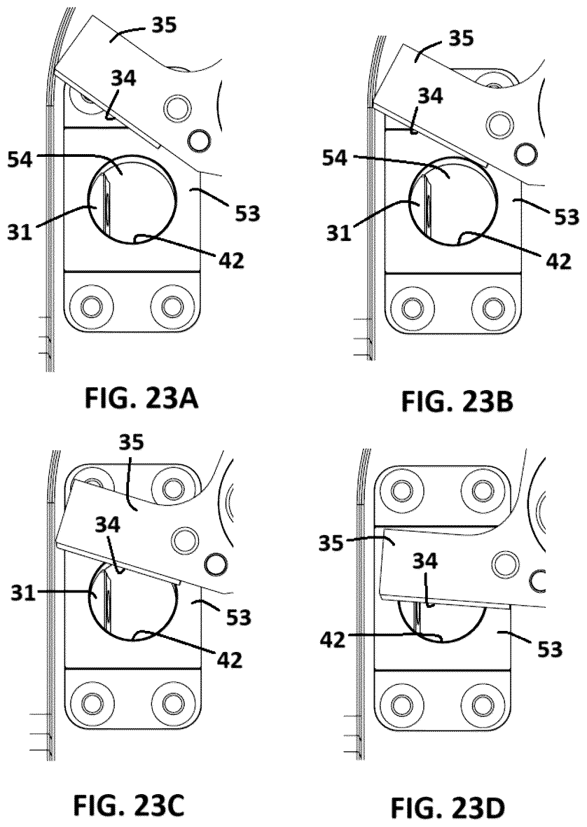

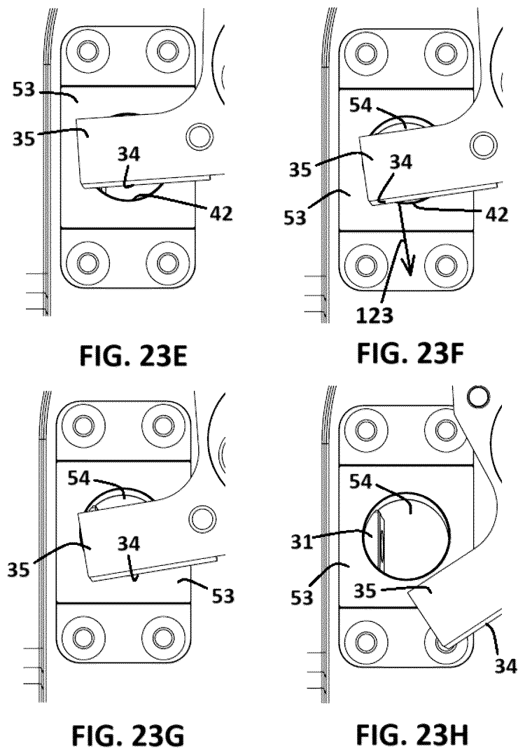

Further referencing FIGS. 23A through 23H, the reader will there consider a sequential presentation of a cutting tool arm 35 and cutting tool 34 sweeping over the scarf-letting aperture 30. When approaching the main aperture axis 121, the sweeping portion 37 and cutting tool 34 are obliquely angled rearward relative to the main aperture axis 121 toward the closed back side 28. When advancing from the main aperture axis 121, the sweeping portion 37 and cutting tool 34 are obliquely angled forward relative to the main aperture axis 121 toward the open front side 29. This configuration allows the sweeping portion 37 and cutting tool 34 to guide the advancing tube scarf 13 away from the hub portion 36 and along the inner diameter of the scarf-letting aperture 30 until it is finally directed into the cutting edge 42 for segmentation after which the scarf segment 22 is directed as at vector 123 in FIG. 23F obliquely relative to the deck outlet plane 122 toward a central portion of the open front side 29.

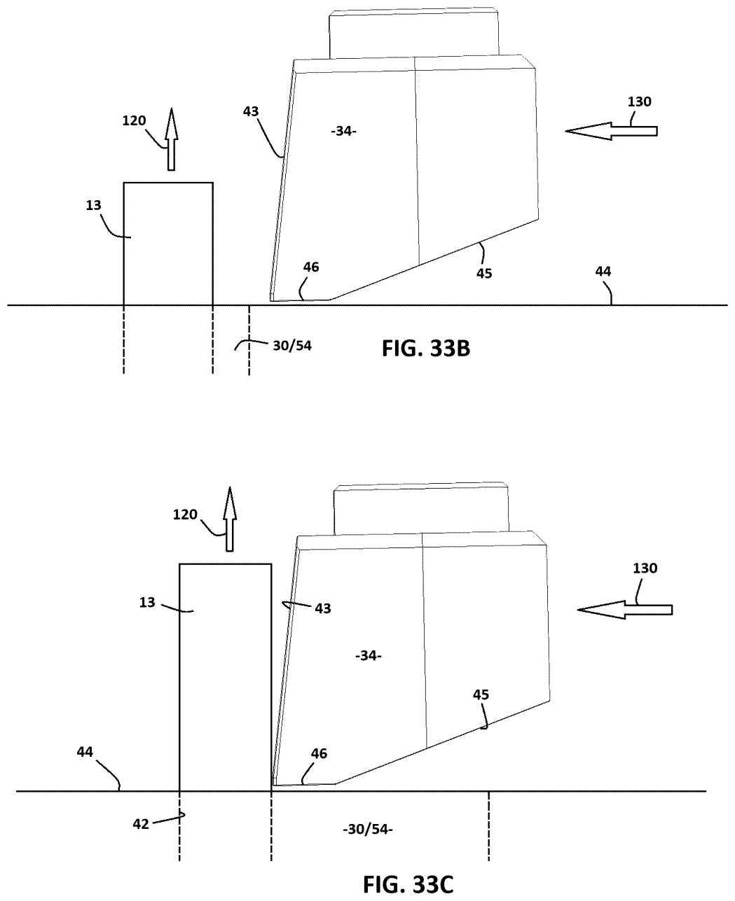

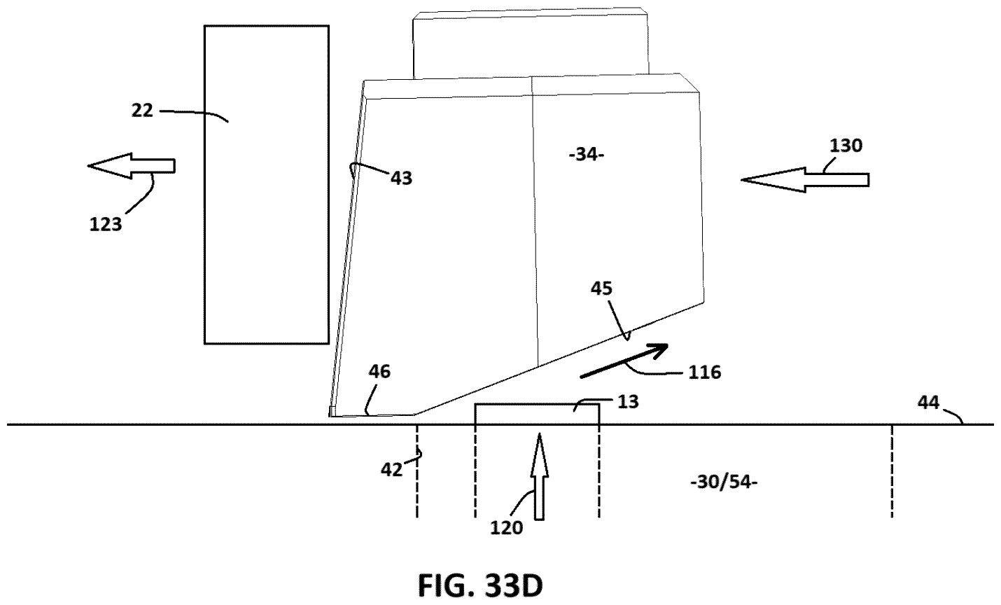

In some embodiments, each cutting tool 34 comprises a sloped leading edge 43. In some embodiments, the sloped leading edge 43 is obliquely angled rearwardly relative to the upper cavity surface 44 of the recessed cavity 39 at a first angle 114 configured to direct the advancing 120 tube scarf 13 toward and against the cutting edge 42 prior to cutting the tube scarf 13 into scarf segments 22 as comparatively depicted in FIGS. 33A through 33C. The first angle 114 reduces the force required to cut the tube scarf 12 and as illustrated is on the order of 83 degrees from the upper cavity surface or 7 degrees from a plane orthogonal thereto.

In some embodiments, each cutting tool 34 may further comprise a sloped trailing edge 45. In some embodiments, the sloped trailing edge 45 is obliquely angled rearwardly relative to the upper cavity surface 44 at a second angle 115. In some embodiments, the second angle 115 is less than the first angle 114 and configured to direct the advancing 120 tube scarf 13 upwardly and rearwardly as at arrow 116 after the tube scarf 13 is cut into scarf segments 22 as generally depicted in FIG. 33D. The sloped trailing edge 45 enables the advancing tube scarf 13 to advance more easily after the cut is made and as illustrated is on the order of 20 degrees from the upper cavity surface 44 or 70 degrees from the plane orthogonal thereto.

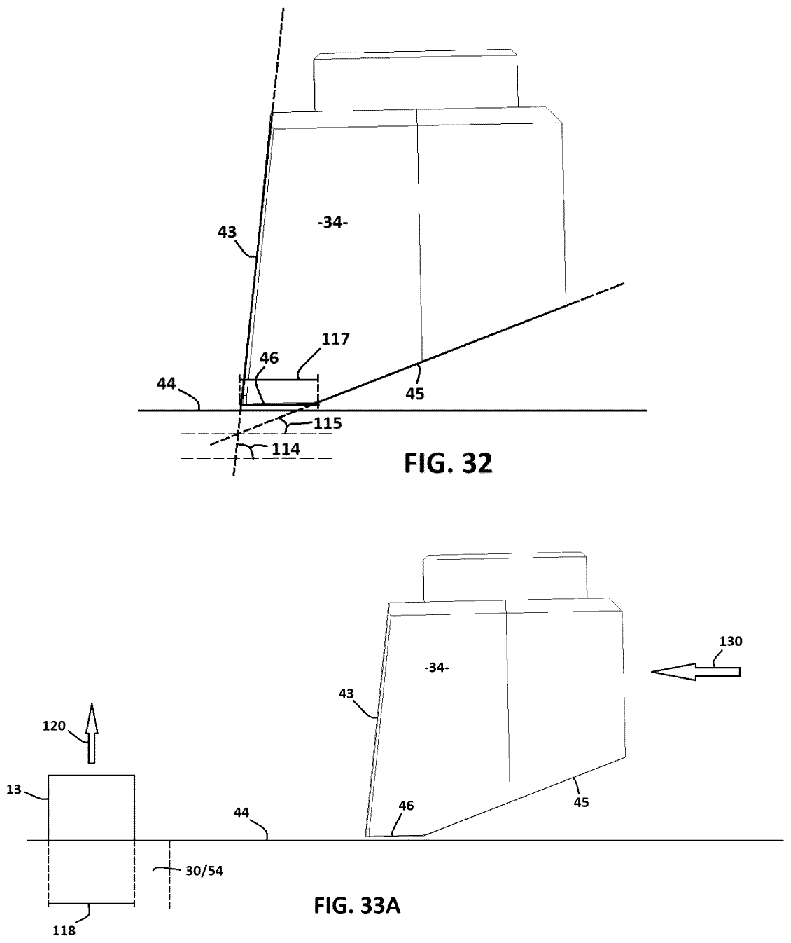

In some embodiments, each cutting tool 34 comprises a surface-opposing portion 46 intermediate the sloped leading edge 43 and the sloped trailing edge 45. The surface-opposing portion 46 extends in parallel relation to the upper cavity surface 44 and comprises a portion thickness 117, which portion thickness 117 is less than a scarf thickness 118 of the tube scarf 13 as comparatively depicted and referenced in FIG. 32 versus FIG. 33A. The portion thickness 117 helps the tube scarf 13 to advance 120 unimpeded at the sloped trailing edge 45 and reduces pinch time as the tube scarf 13 is cut. As illustrated the portion thickness is on the order of 0.13 inches.

In some embodiments, the tube scarf remover and chopper apparatus 10 according to the presently disclosed subject matter may further comprise a lid feature or cavity-enclosing lid 47 that functions to cap the recessed cavity 39 and is cooperably associated with the rotary cutting apparatus 25 for enabling the motor housed within the motor housing 38 to direct rotational motion through a lid aperture 64 formed in the cavity-enclosing lid 47 for supporting the axis of rotation 102 at the rotatably cutting head 33 and enabling rotation thereabout. In some embodiments, the cavity-enclosing lid 47 comprises a segment-directing cavity 48 configured to direct the scarf segments 22 away from the recessed cavity 39 once chopped or cut from the advancing tube scarf 13. The segment-directing cavity 48 comprises a cavity outlet 49 coextensive with the open front side 29 when the cavity-enclosing lid 47 caps the recessed cavity 39 thereby forming an L-shaped segment outlet 50. In some embodiments, the segment-directing cavity 48 comprises sloped surfacing 51 from a cavity terminus portion 52 thereof to the cavity outlet 49, which sloped surfacing 51 directs scarf segments 22 toward the cavity outlet 49.

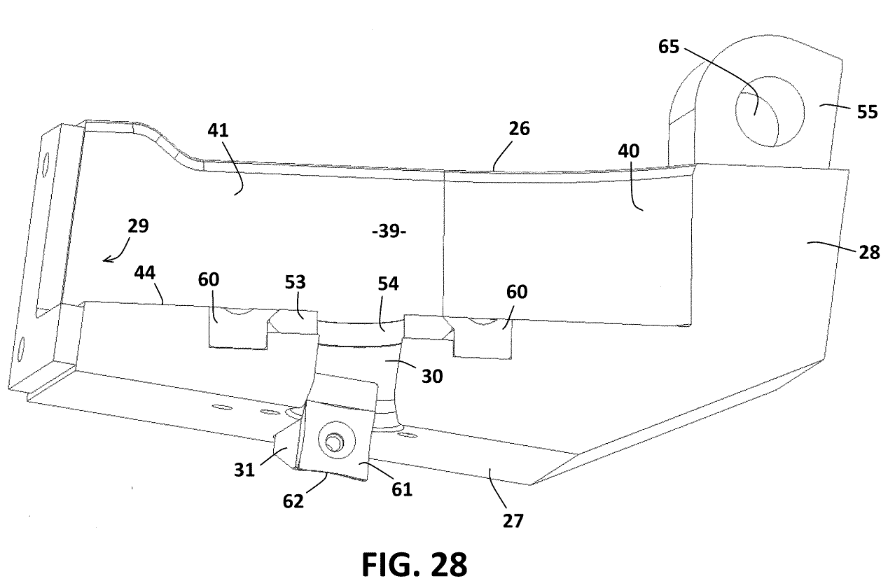

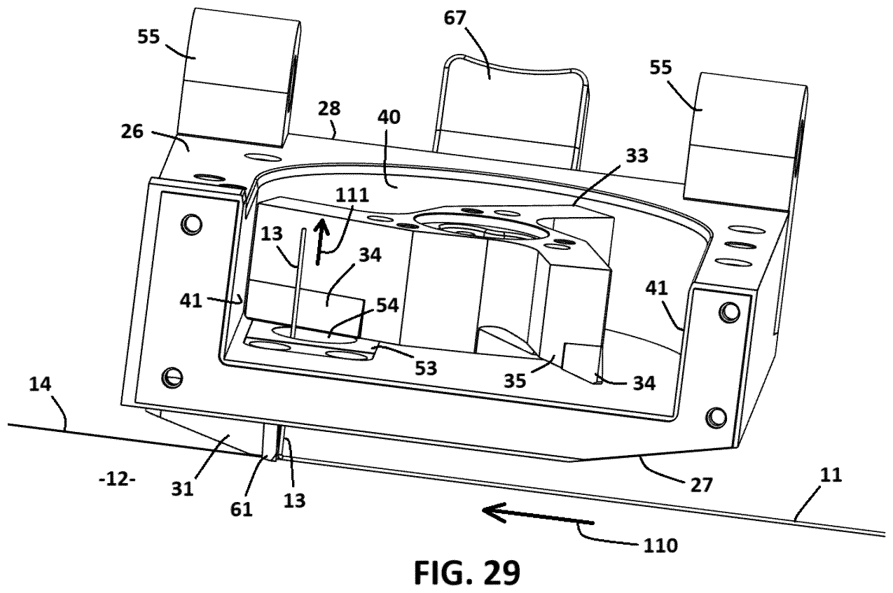

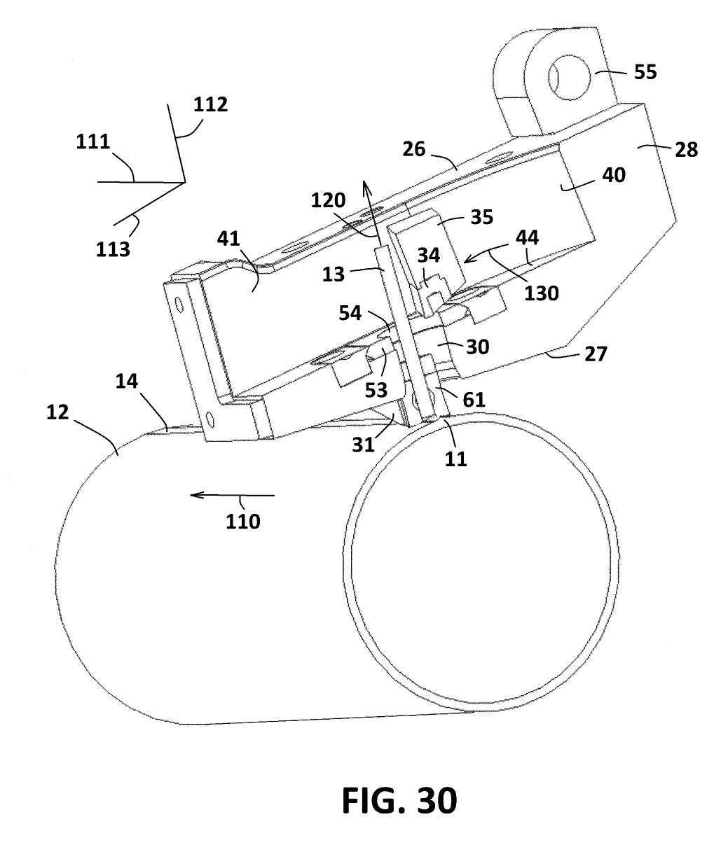

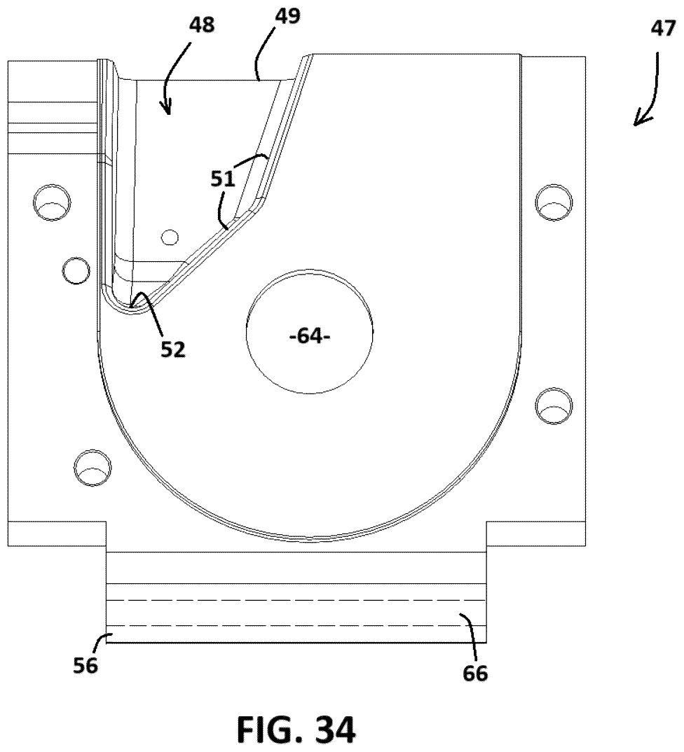

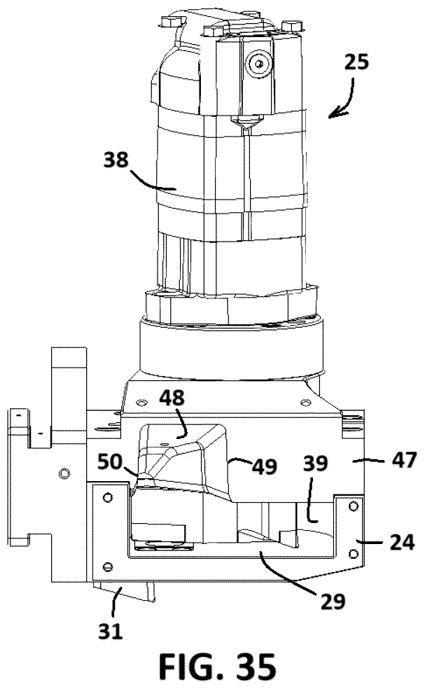

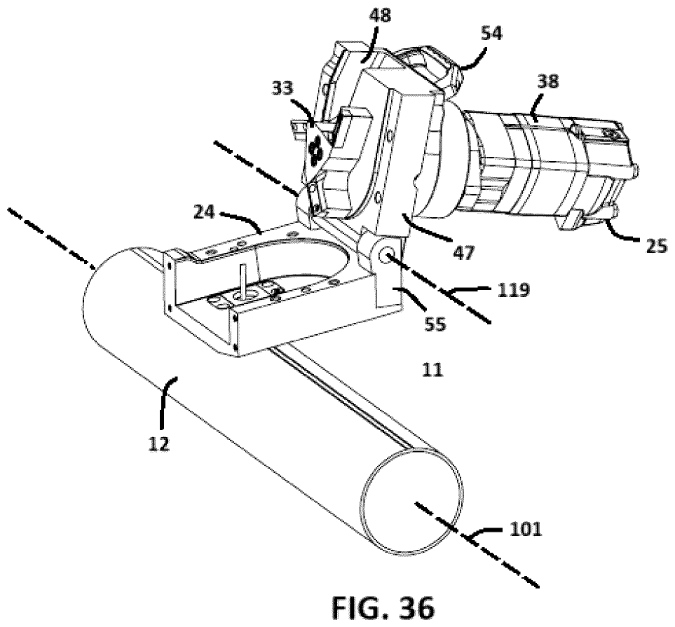

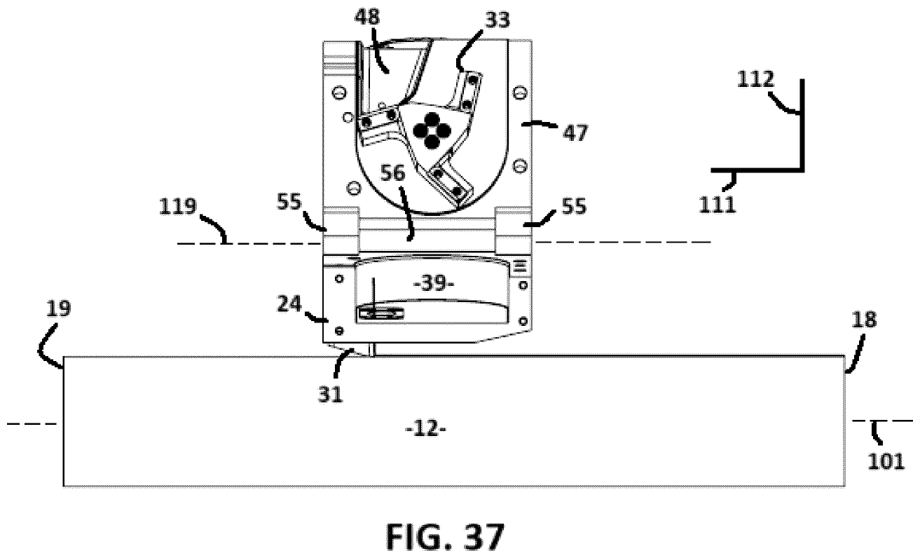

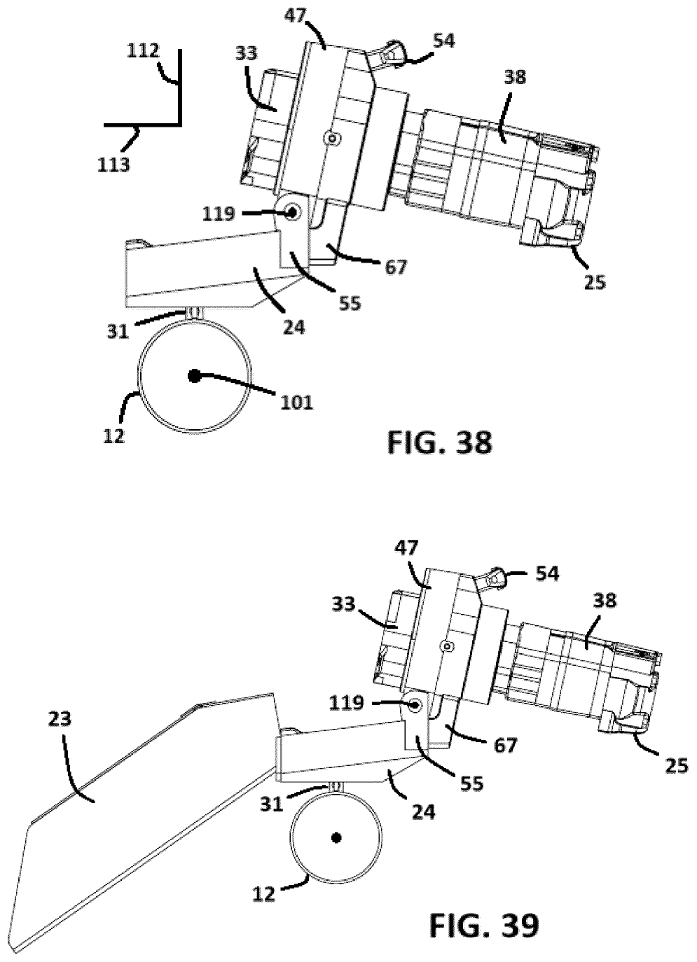

In some embodiments, the rotary cutting apparatus 25 of the tube scarf remover and chopper apparatus 10 is pivotally attached to the cutting deck 24 for enabling a user to access the recessed cavity 39 and the cutting tool(s) 34 when the apparatus 10 is in an open configuration as generally depicted in FIGS. 36 to 39. Referencing FIGS. 36 to 39, the reader will see a pivot axis 119 extending in parallel relation to the longitudinal tube axis 101 along the X axis 111. In some embodiments, the pivot axis 119 is provided by a hinge mechanism or arrangement adjacent the closed rear side 28 of the cutting deck 24. The hinge arrangement providing the pivot axis 119 may comprise laterally opposed deck hinge elements 55 mountable to the closed rear side 28 having bores 65 formed therein as referenced in FIG. 28. The deck hinge elements 55 are alignable with a lid hinge formation 56 formed on the cavity-enclosing lid 47 also comprising a bore 66 as referenced in FIG. 34.

The bores 65 and 66 each have a bore axis such that when the lid hinge formation 56 is received intermediate the laterally opposed deck hinge elements 55, the bore axes become coaxial and define the pivot axis 119. A hinge pin may pivotally couple the lid hinge formation 56 to the laterally opposed deck hinge elements 55. In some embodiments, a handle 54 may be attached to an upper surface of the cavity-enclosing lid 47 to aid the user in pivoting the rotary cutting apparatus 25 and cavity-enclosing lid 47 rearwardly about the pivot axis 119. In some embodiments, the closed rear side 28 of the cutting deck may be outfitted with a support element 67 upon which the rearwardly pivoted rotary cutting mechanism 25 may rest when in the fully pivoted state or open configuration as generally depicted in FIGS. 36 to 39 thereby enabling the user to access the recessed cavity 39, the cutting tools 34 and the scarf-letting plate 53 for the purpose of replacing the cutting tools 34 or scarf-letting plate 53 as may be required.

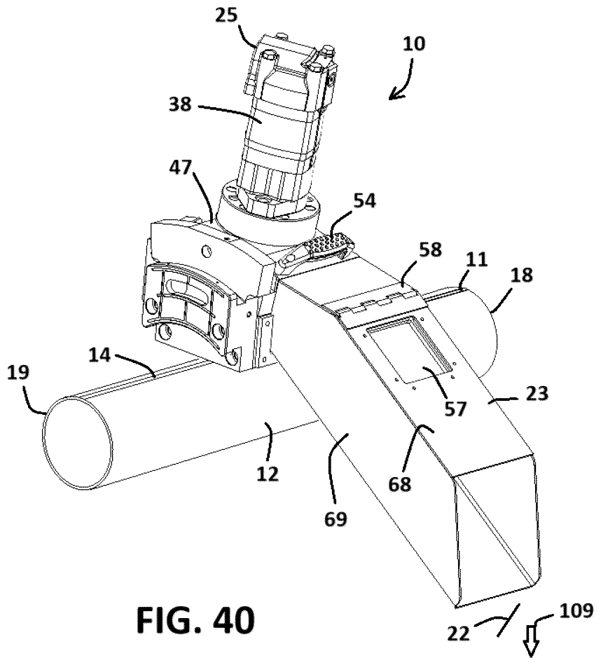

The rotary cutting apparatus 25 may be pivoted about the pivot axis 119 from the open configuration depicted in FIGS. 36 to 39 back to the closed configuration generally depicted in FIG. 40. Referencing FIG. 40, the reader will note the chute 23 is attachable to the open front side 29 of the cutting deck 24 and the front side of the cavity-enclosing lid 47. The chute 23 is configured to redirect scarf segments 22 from the L-shaped segment outlet 50 away from the tube scarf remover and chopper apparatus 10. In some embodiments, the chute 23 may comprise a chute window as at 57 and a chute hinge as at 58. The chute window 57 enables the line operator or user to visually inspect scarf segments 22 as they are directed from the L-shaped outlet 50 while within the chute 23. The chute hinge 58 enables the user to pivot a top chute panel 68 away from the segment directing portion 69 so that the line operator can access internal portions of the chute as necessary. In some embodiments, the top panel 68 may comprise the chute window 57.

Although the presently disclosed subject matter has been described by reference to certain embodiments, it is not intended that the tube scarf remover and chopper apparatus be limited thereby, but that modifications thereof are intended to be included as falling within the broad scope and spirit of the foregoing disclosures and the appended drawings. Insofar as the descriptions above and the accompanying drawings disclose any additional subject matter that is not within the scope of the claims below, the embodiments are not dedicated to the public and the right to file one or more applications to claim such additional embodiments is reserved.

What is claimed is:

1. A tube scarf remover and chopper apparatus for planing a weld bead from a tube and chopping an advancing tube scarf into scarf segments, the tube scarf remover and chopper apparatus comprising:
a cutting deck, the cutting deck having an upper deck side, a lower deck side, a closed rear side, an open front side, and a scarf-letting aperture extending from the lower deck side to the upper deck side through the cutting deck, the scarf-letting aperture having a cutting edge; and
a rotary cutting apparatus, the rotary cutting apparatus comprising a rotatable cutting head and defining an axis of rotation, the rotatable cutting head comprising a cutting tool;
the lower deck side comprising a planing tool configured to plane the weld bead from the tube when said tube is directed thereagainst in a first direction thereby forming an advancing tube scarf, the planing tool continuously directing the advancing tube scarf toward the upper deck side in a second direction transverse to the first direction;
the upper deck side comprising a recessed cavity, the rotatable cutting head being receivable in the recessed cavity such that the axis of rotation extends in parallel relation to the second direction;
the cutting tool being directable in a third direction transverse to the first and second directions toward the advancing tube scarf as continuously directed in the second direction through the scarf-letting aperture;
the cutting tool and the cutting edge together cooperatively cutting the advancing tube scarf into scarf segments as the advancing tube scarf is advanced through the scarf-letting aperture.

2. The tube scarf remover and chopper apparatus according to claim 1, wherein the recessed cavity has a cavity depth and is defined at the closed rear side by a radiused wall portion.

3. The tube scarf remover and chopper apparatus according to claim 2, wherein the radiused wall portion is semicircular.

4. The tube scarf remover and chopper apparatus according to claim 2, wherein the rotatable cutting head has a tool height no greater than the cavity depth.

5. The tube scarf remover and chopper apparatus according to claim 1, wherein the rotatable cutting head comprises a plurality of cutting tool arms radially extending from the axis of rotation.

6. The tube scarf remover and chopper apparatus according to claim 5, wherein the cutting tool arms each comprise a hub portion and a sweeping portion, the sweeping portion being obliquely angled relative to the hub portion.

7. The tube scarf remover and chopper apparatus according to claim 6, wherein the sweeping portion is configured to direct the advancing tube scarf away from the hub portion as the cutting tool passes the scarf-letting aperture.

8. The tube scarf remover and chopper apparatus according to claim 6, wherein the scarf-letting aperture comprises a main aperture axis, the sweeping portion extending obliquely (i) rearwardly relative to the main aperture axis when approaching the scarf-letting aperture and (ii) forwardly when passing the scarf-letting aperture thereby directing the scarf segments in a forward and central direction toward the open front side.

9. The tube scarf remover and chopper apparatus according to claim 1, wherein the cutting tool comprises a sloped leading edge, the sloped leading edge being obliquely angled relative to an upper cavity surface of the recessed cavity at a first angle configured to direct the advancing tube scarf toward and against the cutting edge prior to cutting said tube scarf into scarf segments.

10. The tube scarf remover and chopper apparatus according to claim 9, wherein the cutting tool comprises a sloped trailing edge, the sloped trailing edge being obliquely angled relative to the upper cavity surface at a second angle, the second angle being lesser than the first angle, the second angle being configured to direct the advancing tube scarf upwardly and rearwardly after the cutting tool passes the scarf-letting aperture.

11. The tube scarf remover and chopper apparatus according to claim 10, wherein the cutting tool comprises a surface-opposing portion intermediate the sloped leading edge and the sloped trailing edge, the surface-opposing portion extending in parallel relation to the upper cavity surface.

12. The tube scarf remover and chopper apparatus according to claim 11, wherein the surface-opposing portion comprises a portion thickness, the portion thickness being less than a scarf thickness of the advancing tube scarf, the portion thickness for enabling the advancing tube scarf to advance at the sloped trailing edge.

13. The tube scarf remover and chopper apparatus according to claim 1 comprising a cavity-enclosing lid positioned adjacent the rotatable cutting head such that the rotary cutting head is capped within the recessed cavity.

14. The tube scarf remover and chopper apparatus according to claim 13, wherein the cavity-enclosing lid is pivotally attached to the cutting deck and pivotal about a pivot axis for enabling a user to gain access to the recessed cavity.

15. The tube scarf remover and chopper apparatus according to claim 13, wherein the cavity-enclosing lid comprises a segment-directing cavity configured to direct the scarf segments away from the recessed cavity.

16. The tube scarf remover and chopper apparatus according to claim 15, wherein the segment-directing cavity comprises a cavity mouth coextensive with the open front side thereby forming an L-shaped segment outlet.

17. The tube scarf remover and chopper apparatus according to claim 15, wherein the segment-directing cavity comprises sloped surfacing from a cavity terminus portion thereof to the cavity mouth, the sloped surfacing for directing the scarf segments toward the cavity mouth.

18. The tube scarf remover and chopper apparatus according to claim 16 comprising a chute in communication with the L-shaped segment outlet configured to direct the scarf segments from the L-shaped segment outlet.

19. The tube scarf remover and chopper apparatus according to claim 1, wherein the cutting deck comprises a plate-receiving cavity, a replaceable scarf-letting plate having a plate aperture being receivable in the plate-receiving cavity, the plate aperture providing the cutting edge.

20. A tube scarf chopper apparatus for chopping an advancing tube scarf, the tube scarf chopper apparatus comprising:
a cutting deck having a first deck side, a second deck side, a rear side, a front side, and a scarf-letting aperture extending from the first deck side to the second deck side through the cutting deck, the scarf-letting aperture having a cutting edge; and
a rotary cutting apparatus, the rotary cutting apparatus comprising a rotatable cutting head and an axis of rotation, the rotatable cutting head comprising a cutting tool;
the second deck side comprising a recessed cavity, the rotatable cutting head being receivable in the recessed cavity such that the axis of rotation extends in parallel relation to a tube scarf advancing through the scarf-letting aperture;
the cutting tool being directable transversely relative to the tube scarf so advancing, the cutting tool and the cutting edge together cooperatively cutting the tube scarf into scarf segments as the tube scarf advances through the scarf-letting aperture.
